(19) United States
(12) Patent Application Publication
(10) Pub. No.: US 2026/0128280 A1
(43) Pub. Date: May 7, 2026

(54) ELECTROACTIVE COMPOSITE PARTICLES

(71) Applicant: NEXEON LIMITED, Abingdon Oxfordshire (GB)

(72) Inventors: Joshua WHITTAM, Abingdon Oxfordshire (GB); Charles MASON, Abingdon Oxfordshire (GB); Akifumi NAKAMURA; Daniel SCARLETT, Abingdon Oxfordshire (GB); Chris FRIEND, Abingdon Oxfordshire (GB)

(73) Assignee: NEXEON LIMITED, Abingdon Oxfordshire (GB)

(21) Appl. No.: 19/126,003

(22) PCT Filed: Oct. 31, 2023
(86) PCT No.: PCT/GB2023/052848

§ 371 Date: Sep. 24, 2025

(30) Foreign Application Priority Data
Oct. 31, 2022 (GB) 2216145.9
Aug. 11, 2023 (GB) 2312362.3

(51) Int. Cl. H01M 4/36; H01M 4/02; H01M 4/38; H01M 4/62

(52) U.S. Cl. CPC H01M 4/362; H01M 4/386; H01M 4/625; H01M 2004/021

(57) ABSTRACT

This invention relates to a process for preparing composite particles, the process comprising the deposition of a plurality of electroactive material domains in the pores of porous particles, wherein the porous particles comprise micropores and mesopores and have a D1 particle diameter of at least 0.5 μm and a D50 particle diameter in the range from 1 to 20 μm.

### INTRODUCTION

This invention relates to a process for the preparation of composite particles comprising an electroactive material deposited into the pores of a porous particle framework. The process of the invention relates in particular to a process for the preparation of composite particles using a porous particle starting material of controlled particle size and pore size distribution. The invention also relates to composite particles comprising a porous particle framework and a plurality of electroactive domains located within the pores of the porous particle framework, wherein the composite particles have controlled particle size and pore size distribution.

### BACKGROUND TO THE INVENTION

Lithium-ion batteries (LIBs) comprise in general an anode, a cathode and a lithium-containing electrolyte. The anode generally comprises a metal current collector provided with a layer of an electroactive material, defined herein as a material which is capable of inserting and releasing lithium ions during the charging and discharging of a battery. When a LIB is charged, lithium ions are transported from the cathode via the electrolyte to the anode and are inserted into the electroactive material of the anode as intercalated lithium atoms. The terms “cathode” and “anode” are therefore used herein in the sense that the battery is placed across a load, such that the anode is the negative electrode. The term “battery” is used herein to refer both to devices containing a single lithium-ion cell and to devices containing multiple connected lithium-ion cells.

LIBs were developed in the 1980s and 1990s and have since found wide application in portable electronic devices. The development of electric or hybrid vehicles in recent has created a significant new market for LIBs and renewable energy sources have created further demand for on-grid energy storage which can be met at least in part by LIB farms. Overall, global production of LIBs is projected to grow from around 290 GWh in 2018 to over 2,000 GWh in 2028.

Alongside the growth in total storage capacity, there is significant interest in improving the gravimetric and/or volumetric capacities of rechargeable metal-ion batteries such that the same energy storage is achieved with less battery mass and/or less battery volume. Conventional LIBs use graphite as the anode electroactive material. Graphite anodes can accommodate a maximum of one lithium atom for every six carbon atoms resulting in a maximum theoretical specific capacity of 372 mAh/g in a lithium-ion battery, with a practical capacity that is somewhat lower (ca. 340 to 360 mAh/g).

Silicon is a promising alternative to graphite because of its very high capacity for lithium (see, for example, Insertion Electrode Materials for Rechargeable Lithium Batteries, Winter, M. et al. in Adv. Mater. 1998, 10, No. 10). Silicon has a theoretical maximum specific capacity of about 3,600 mAh/g in a lithium-ion battery (based on Li₁₅Si₄). However, such a high ratio of intercalated lithium to silicon results in expansion of the silicon material by up to 400% of its original volume. Repeated charging and discharging cycles result in significant mechanical stress on the silicon material leading to fracturing and structural failure. Furthermore, the charging of anodes in LIBs results in the formation of a solid electrolyte interphase (SEI) layer. This SEI layer is an ion-conductive yet insulating layer that is formed by the reductive decomposition of electrolytes on exposed electrode surfaces during the initial charge. In a graphite anode, this SEI layer is relatively stable during subsequent charge/discharge cycles. However, the expansion and contraction of a silicon anode results in fracturing and delamination of the SEI layer and the exposure of fresh silicon surface, resulting in further electrolyte decomposition, increased thickness of the SEI layer and irreversible consumption of lithium. These failure mechanisms collectively result in an unacceptable loss of electrochemical capacity over successive charging and discharging cycles.

The present inventors have previously reported the development of a class of electroactive materials having a composite structure in which electroactive materials, such as silicon, are deposited into the pore network of highly porous particles, e.g. a porous carbon material, having a carefully controlled pore size distribution. For example, WO 2020/095067 and WO 2020/128495 report that the improved electrochemical performance of these materials can be attributed to the way in which the electroactive materials form small domains with dimensions of the order of a few nanometres or less within the pore network of the porous particles, which thus function as a framework for the composite particles. The fine electroactive structures are thought to have a lower resistance to elastic deformation and higher fracture resistance than larger electroactive structures, and are therefore able to lithiate and delithiate without excessive structural stress. As a result, the electroactive materials exhibit good reversible capacity retention over multiple charge-discharge cycles. Secondly, by controlling the loading of silicon within the porous carbon framework such that only part of the pore volume is occupied by silicon in the uncharged state, the unoccupied pore volume of the porous carbon framework is able to accommodate a substantial amount of silicon expansion internally. Excessive expansion is constrained by the particle framework. Furthermore, only a small area of the electroactive material surface is accessible to electrolyte and so SEI formation is substantially prevented.

In WO 2022/029422, the applicant has reported a further development in which control of the distribution of electroactive silicon within the pore network of the particle framework results in still a further improvement in the electrochemical performance of the composite particles. Specifically, the applicant has shown that electrochemical performance is optimised when the length scale of the individual silicon structures in the composite particles is minimised such that a large proportion of the silicon atoms are in a surface region of the silicon structures, with a relatively smaller proportion of silicon atoms located inside bulky/coarse silicon structures. The applicant has identified an optimised pore structure of the porous particle framework and a set of conditions for the deposition of silicon into the porous particle framework that allows for an increased proportion of this so-called “surface silicon” while also ensuring a large amount of silicon in total is incorporated into the composite particles to meet overall volumetric energy density requirements.

There remains a need in the art for further improvements to electroactive composite particles of the type described above to provide improvements in electrochemical performance and longevity of the materials over multiple charge discharge cycles.

### SUMMARY OF THE INVENTION

In a first aspect, the invention provides a process for preparing composite particles, the process comprising the steps of:
(a) providing a plurality of porous particles comprising micropores and mesopores,
   wherein the micropores and mesopores have a total pore volume as measured by nitrogen gas adsorption of 0.4 to 2.0 cm³/g, and wherein the porous particles have a D₁ particle diameter of at least 0.5 μm, and a D₅₀ particle diameter in the range from 1 to 20 μm;
(b) contacting the porous particles with a precursor of an electroactive material at a temperature effective to cause deposition of a plurality of electroactive material domains in the pores of the porous particles.

The invention therefore relates in general terms to a process for preparing composite particles in which thermal decomposition of a silicon-containing precursor material is used to deposit a plurality of nanoscale silicon domains into the pore network of porous particles comprising micropores and mesopores. This type of deposition process is termed chemical vapour infiltration (CVI). The composite particles produced according to the process of the invention therefore comprise a first component in the form of porous particle framework that is derived from the porous particles provided in step (a), and a second component in the form of a plurality of nanoscale silicon domains that are deposited within the pore structure of the porous particle framework in step (b). As used herein, the term “nanoscale silicon domain” refers to a nanoscale body of elemental silicon having maximum dimensions that are determined by the location of the silicon within the micropores and/or mesopores of the porous particles.

The process of the invention builds upon prior disclosures by the applicant by the recognition that the presence of particle fines has a particularly deleterious effect on the product properties. Earlier work in this area has focused on the definition of composite particles (and the porous particle frameworks used to produce them) in terms of their D₁₀, D₅₀ and D₉₀ particle diameters. However, the presence of particle fines and their effect on the production of, and use of, composite particles of the type disclosed herein has received little attention. Even with the D₁₀ value of the particles specified, fines still constitute up to 10 vol % of the total particle volume and a far larger proportion of the particle number distribution and of the external particle surface area given the small particle size of the fines.

The problems associated with the use of particle fines depend essentially on two factors—cohesiveness and surface area, which is related both to particle size and the pore size distribution. Particle cohesion becomes an increasingly significant factor as particle size decreases. This is due to an increase in attractive forces, such as Van der Waals forces, as the surface area increases. This is relevant during the manufacture of composite particles, especially with a thermal infiltration and deposition manufacturing process where solid-gas contact behaviour is a critical factor, not only because excessive cohesiveness makes handling of the porous particle starting material more difficult, but also because it has a negative effect on the homogenous distribution of the particles within a reaction vessel. This in turn contributes to a sub-optimal distribution of the deposition electroactive material in the composite particle product.

Similarly, the presence of outsize particles has received little attention in the art. Even with the D₉₀ value of the particles specified, outsize particles still constitute up to 10 vol % of the total particle volume and have a disproportionate effect on performance. It has been discovered that even a small number of over-sized particles remaining within the composite particle population can significantly degrade the performance of electrode compositions. Excessively sized composite particles cannot pack efficiently and therefore create inhomogeneities in electrode layer. These inhomogeneities affect particle-to-particle connectivity, have different charging behaviour, and are more prone to fracture.

Maintaining a tight distribution between the D₉₈ and D₁ particle sizes of the porous particle population has also been found to be important in ensuring homogenous distribution of the porous particles within the reactor vessel during vapour deposition of the electromagnetic material into them, both to ensure a homogenous distribution of the mass of electromagnetic material per particle but also ensure good distribution of the electromagnetic material within the particles, avoiding excess deposition on the external surfaces of the porous particles.

The present invention relates in particular to composite particles and a process for making them in which the particle size distribution, total pore volume and the pore size distribution are carefully tailored to achieve fine electroactive structures in the form of small domains with dimensions of the order of a few nanometres or less. The morphology of the electroactive material can be analysed by thermogravimetric analysis (TGA). Atoms at or near the surface of an electroactive nanostructure are oxidized at a lower temperature than atoms in the bulk (reference: Bardet et al., Phys. Chem. Chem. Phys. (2016), 18, 18201). By plotting the weight gain against temperature, it is possible to differentiate and quantify the environment of the atoms of the electroactive material in the sample.

As noted above, WO 2022/029422, uses the term “surface silicon” to refer to silicon atoms in a surface region of the silicon nanostructures, and the term “coarse bulk silicon” to refer to silicon atoms located inside bulky/coarse silicon structures. It has been found that optimum performance is achieved when there is a high ratio of “surface silicon” to “coarse bulk silicon”. WO 2022/029422 identifies an optimised pore structure of the porous particle framework and a set of conditions for the deposition of silicon into the porous particle framework that allows for an increased proportion of this so-called “surface silicon” while also ensuring a large amount of silicon in total is incorporated into the composite particles to meet overall volumetric energy density requirements.

The applicant has now identified that the distribution of the electroactive material between coarse and fine nanostructures is dependent on the presence of fines. Without being bound by theory, it is believed that agglomeration of particles creates interstitial spaces where coarse electroactive structures can form. Eliminating fines from the porous particle starting material correspondingly reduces the tendency of coarse electroactive material structures to form. Furthermore, the possibility for the agglomerated particles to be dislodged during electrode manufacture or initial charging of the electrode results in increased exposure of silicon surfaces which may oxidise and/or form SEI layers, and/or degrade conductivity. These mechanisms together contribute to an overall loss of capacity of the composite particles.

As noted above, the surface area of the material is particularly sensitive to the presence of fines, since smaller particles make a disproportionate contribution to the surface area. Small variations in the quantity of fines between batches can therefore create a large variability in the processing parameters. This means that the use of a starting material of controlled surface area may nonetheless lead to deviations in surface area of the composite particles after the electroactive material is deposited, due to variations in the contribution of fines to the total surface area. This is in addition to any effects due to cohesion/agglomeration of the fine particles. A change in the surface area of the composite particles has consequences for the further processing of the composite particles into electrodes, in particular with regard to the binder content of the electrode composition.

It has therefore been found that the removal of fines from the porous particle starting material provides for better repeatability during the deposition of an electroactive material to form composite particles. It furthermore prevents cohesion and therefore reduces the formation of coarse electroactive material structures during deposition of the electroactive material, and correspondingly increases the proportion of fine electroactive material structures. The removal of fines furthermore reduces the formation of SEI layers and therefore reduces the irreversible capacity loss that occurs on the first charge/discharge cycle, thereby increasing the cyclability of electrodes comprising the composite particles.

In a second aspect, the invention provides a particulate material consisting of a plurality of composite particles, wherein the composite particles comprise:
(a) a porous particle framework comprising micropores and mesopores, wherein the micropores and mesopores have a total pore volume as measured by nitrogen gas adsorption of 0.4 to 2.0 cm³/g, and
(b) a plurality of nanoscale electroactive material domains located within the pores of the porous particle framework,
   wherein the composite particles have a D₁ particle diameter of at least 0.5 μm, and a D₅₀ particle diameter in the range from 1 to 20 μm.

In a third aspect, the invention provides a composition comprising the particulate material of the second aspect and at least one other component.

In a fourth aspect, the invention provides an electrode comprising the particulate material of the second aspect or the composition of the third aspect.

In a fifth aspect, the invention provides a rechargeable metal-ion battery comprising the electrode of the fourth aspect.

### DESCRIPTION OF THE FIGURES

FIG. 1 shows the TGA trace for a particulate material according to the invention, comprising a high level of surface silicon and a low level of bulk coarse silicon.

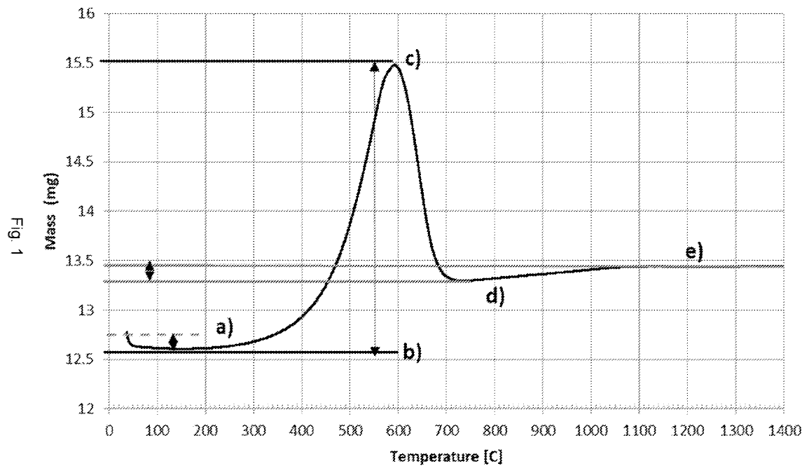

FIG. 2 shows the TGA trace for a particulate material comprising a low level of surface silicon and a high level of bulk coarse silicon.

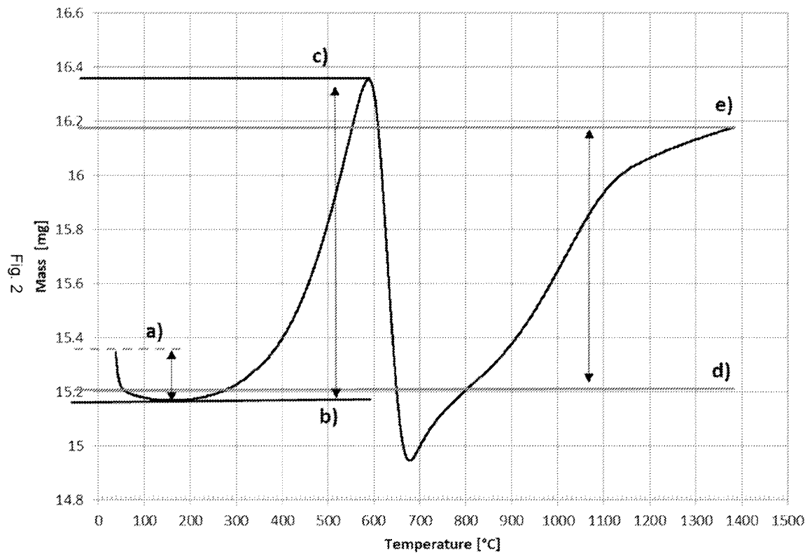

FIG. 3 shows the instantaneous flow functions of samples from Example 2.

FIG. 4 shows the instantaneous flow functions of samples from Example 3.

### DETAILED DESCRIPTION OF THE INVENTION

The process of the first aspect of the invention comprises the steps of:
(a) providing a plurality of porous particles comprising micropores and mesopores
   wherein the micropores and mesopores have a total pore volume as measured by nitrogen gas adsorption of 0.4 to 2.0 cm³/g, and wherein the porous particles have a D₁ particle diameter of at least 0.5 μm, and a D₅₀ particle diameter in the range from 1 to 20 μm;
(b) contacting the porous particles with a precursor of an electroactive material at a temperature effective to cause deposition of a plurality of electroactive material domains in the pores of the porous particles.

The porous particles function as a framework for the electroactive material, which is typically deposited in the form of a plurality of electroactive material domains. The term “electroactive material domain” refers to a body of electroactive material, e.g. elemental silicon, having maximum dimensions that are determined by the dimensions of the micropores and/or mesopores of the porous particles in which they are located. The electroactive domains may therefore be described as nanoscale electroactive domains, wherein the term “nanoscale” is understood to refer generally to dimensions less than 100 nm. Although, due to the dimensions of micropores and mesopores, the electroactive material domains typically have maximum dimensions in any direction of less than 50 nm, and usually significantly less than 50 nm. A domain may for example take the form of a regular or irregular particle or a bounded layer or region of coating.

The process of the present invention is characterized by the use of a porous particle starting material having a D₁ particle diameter of at least 0.5 μm in combination with a carefully controlled pore volume and pore size distribution. Taken together, these factors ensure that composite particles are obtained having a high content of “surface silicon” as compared to the use of starting materials in which particle fines are present in the porous particle starting material. Preferably, the D₁ particle diameter of the porous particles is at least 0.8 μm, or at least 1.0 μm, or at least 1.2 μm, or at least 1.4 μm, or at least 1.5 μm, or at least 1.6 μm, or at least 1.8 μm, or at least 2.0 μm, or at least 2.2 μm, or at least 2.4 μm, or at least 2.5 μm, or at least 2.6 μm, or at least 2.8 μm, or at least 3.0 μm.

In general, the porous particles have a D₅₀ particle diameter in the range from 1 to 20 μm. Preferably, the D₅₀ particle diameter of the porous particles is at least 1.5 μm, or at least 2 μm, or at least 2.5 μm, or at least 3 μm. Preferably, the D₅₀ particle diameter of the porous particles is no more than 18 μm, or no more than 15 μm, or no more than 12 μm, or no more than 10 μm, or no more than 8 μm. For example, the D₅₀ particle diameter of the porous particles may be in the range from 1.5 to 18 μm, or in the range from 1.5 to 15 μm, or in the range from 2 to 12 μm, or in the range from 2 to 10 μm, or in the range from 2.5 to 8 μm, or in the range from 3 to 8 μm.

The D₉₀ particle diameter of the porous particles is preferably no more than 30 μm, or no more than 25 μm, or no more than 20 μm, or no more than 18 μm, or no more than 15 μm, or no more than 13 μm, or no more than 12 μm.

Preferably, the D₁ particle diameter is in the range from 0.8 to 5.0 μm and the D₉₀ particle diameter is in the range from 6 to 15 μm, preferably the D₁ particle diameter is in the range from 1.0 to 5.0 μm and the D₉₀ particle diameter is in the range from 7.5 to 15 μm, preferably the D₁ particle diameter is in the range from 1.5. to 4.5 μm and the D₉₀ particle diameter is in the range from 9 to 15 μm, preferably wherein the D₁ particle diameter is in the range from 2 to 4 μm and the D₉₀ particle diameter is in the range from 10 to 14 μm, preferably wherein the D₁ particle diameter is in the range from 2.5 to 3.5 μm and the D₉₀ particle diameter is in the range from 11 to 13 μm.

The D₉₈ particle diameter of the porous particles is preferably no more than 35 μm, or no more than 30 μm, or no more than 25 μm, or no more than 20 μm, or no more than 18 μm, or no more than 16 μm, or no more than 15.5 μm, or no more than 15 μm, or no more than 12 μm.

The D₁₀₀ particle diameter of the porous particles is preferably no more than 40 μm, or no more than 35 μm, or no more than 30 μm, or no more than 25 μm, or no more than 20 μm, or no more than 16 μm.

The deposition of electroactive materials into porous particles that are excessively large may be less efficient due to the longer distance that precursor molecules must diffuse through the pore structure to reach the innermost pores. Deposition of the electroactive material in pores nearer to the particle surface can obstruct access of the precursor molecules to the innermost pores, resulting in particles that are underfilled and thus non-homogenous deposition of the electroactive material between particles of different sizes Also, as discussed above, outsize particles also pack less efficiently and therefore obstruct the formation of electrode layers of homogenous structure and composition.

Preferably, the difference between the D₉₈ particle diameter and the D₁ particle diameter of the porous particles (D₉₈−D₁) is no more than 18 μm, or no more than 16 μm, or no more than 15 μm, or no more than 14 μm, or no more than 13 μm, or no more than 12 μm. As set out above, controlling both the D₁ particle diameter and the D₉₈ particle diameter provides a solution to the problems associated with both fine particles and outsize particles. In particular, by maintaining a small particle size distribution between the D₁ and D₉₈ particle sizes, the present invention provides a population of composite particles which is able to pack efficiently in electrode layers and which also provides for efficient and homogenous thermal infiltration and deposition behaviour during manufacture of the composite particles.

Preferably, the ratio of the D₉₈ particle diameter to the D₁ particle diameter of the porous particles (D₉₈/D₁) is no more than 12, or no more than 10, or no more than 8, or no more than 6, or no more than 5.

Preferably, (D₉₈−D₁)/D₅₀ is no more than 2.2, or no more than 2, or no more than 1.9, or no more than 1.8, or no more than 1.7, or no more than 1.6.

Preferably, the difference between the D₉₀ particle diameter and the D₁ particle diameter of the porous particles (D₉₀−D₁) is no more than 12.0 μm, or no more than 10.0 μm, or no more than 9.0 μm, or no more than 8.0 μm.

Preferably, the ratio of the D₉₀ particle diameter to the D₁ particle diameter of the porous particles (D₉₀/D₁) is no more than 12.0, or no more than 10.0, or no more than 9.0, or no more than 8.0, or no more than 7.0, or no more than 6.0, or no more than 5.0.

Preferably, (D₉₀−D₁)/D₅₀ is no more than 2.2, or no more than 2, or no more than 1.9, or no more than 1.8, or no more than 1.7, or no more than 1.6.

The porous particles preferably have a narrow particle size distribution span. For instance, the particle size distribution span (defined as (D₉₀−D₁₀)/D₅₀) is preferably 3 or less, more preferably 2 or less, more preferably 1.5 or less and most preferably 1.2 or less. By maintaining a narrow particle size distribution span, efficient packing of the particles into dense powder beds is more readily achievable.

The ratio of the D₅₀ particle diameter to the D₁ particle diameter of the porous particles (D₅₀/D₁) is preferably no more than no more than 10.0, or no more than 8.0, or no more than 7.0, or no more than 6.0, or no more than 5.0, or no more than 4.0, or no more than 3.0, or no more than 2.5. For example, the ratio of the D₅₀ particle diameter to the D₁ particle diameter of the porous particles in the range from 2.0 to 10.0, or from 2.0 to 8.0, or from 2.0 to 5.0, or from 2.0 to 4.0.

The ratio of the D₁₀₀ particle diameter to the D₅₀ particle diameter of the porous particles is preferably no more than 3, or no more than 2.5 or no more than 2.

Preferred porous particles include those in which the D₁ particle diameter is at least 1.0 μm and the ratio of the D₅₀ particle diameter to the D₁ particle diameter is no more than 5.0, or no more than 4.0, or no more than 3.0.

Preferred porous particles also include those in which the D₁ particle diameter is at least 1.0 μm and the ratio of the D₉₀ particle diameter to the D₁ particle diameter of the porous particles (D₉₀/D₁) is no more than 9.0, or no more than 8.0, or no more than 7.0, or no more than 6.0, or no more than 5.0.

Preferred porous particles also include those in which the D₁ particle diameter is at least 1.0 μm and the difference between the D₉₀ particle diameter and the D₁ particle diameter of the porous particles (D₉₀−D₁) is no more than 10.0 μm, or no more than 9.0 μm, or no more than 8.0 μm.

Preferred porous particles also include those in which the D₁ particle diameter is at least 1.0 μm and the ratio of the D₉₈ particle diameter to the D₁ particle diameter of the porous particles (D₉₈/D₁) is no more than 10, or no more than 8.

Preferred porous particles also include those in which the D₁ particle diameter is at least 1.0 μm and the difference between the D₉₈ particle diameter and the D₁ particle diameter of the porous particles (D₉₈−D₁) is no more than 15 μm, or no more than 14 μm, or no more than 13 μm, or no more than 12 μm.

Preferred porous particles also include those in which the D₁ particle diameter is at least 1.0 μm and (D₉₈−D₁)/D₅₀ is no more than 2, or no more than 1.9, or no more than 1.8, or no more than 1.7, or no more than 1.6.

Preferred porous particles include those in which the D₁ particle diameter is at least 1.5 μm and the ratio of the D₅₀ particle diameter to the D₁ particle diameter is no more than 6.0, or no more than 5.0, or no more than 4.0, or no more than 3.0.

Preferred porous particles also include those in which the D₁ particle diameter is at least 1.5 μm and the ratio of the D₉₀ particle diameter to the D₁ particle diameter of the porous particles (D₉₀/D₁) is no more than 10.0, or no more than 9.0, or no more than 8.0, or no more than 7.0, or no more than 6.0, or no more than 5.

Preferred porous particles also include those in which the D₁ particle diameter is at least 1.5 μm and the difference between the D₉₀ particle diameter and the D₁ particle diameter of the porous particles (D₉₀−D₁) is no more than 10.0 μm, or no more than 9 μm, or no more than 8.0 μm.

Preferred porous particles also include those in which the D₁ particle diameter is at least 1.5 μm and the ratio of the D₉₈ particle diameter to the D₁ particle diameter of the porous particles (D₉₈/D₁) is no more than 12, or no more than 10, or no more than 8.

Preferred porous particles also include those in which the D₁ particle diameter is at least 1.5 μm and the difference between the D₉₈ particle diameter and the D₁ particle diameter of the porous particles (D₉₈−D₁) is no more than 18 μm, or no more than 16 μm, or no more than 15 μm, or no more than 14 μm, or no more than 13 μm, or no more than 12 μm.

Preferred porous particles also include those in which the D₁ particle diameter is at least 1.5 μm and (D₉₈−D₁)/D₅₀ is no more than 2, or no more than 1.9, or no more than 1.8, or no more than 1.7, or no more than 1.6.

The porous particles preferably have a positive skew in the volume-based distribution, for example, such that the volume based distribution is asymmetric with a longer tail on the right hand side. A positive skew in the volume-based particle diameter distribution is advantageous since the natural packing factor will be higher than if all particles are the same size, thereby reducing the need for calendering or other physical densification processes when the composite particle product is formed into an electrode layer. Preferably, the D₅₀ particle diameter is less than the volume-based mean of the particle diameter distribution (D[4.3]). Preferably, the skew of the particle diameter distribution (as measured by a Malvern Mastersizer™ 3000 analyzer) is no more than 5, or no more than 3, preferably no more than 2. Preferably, the skew is at least 0.2, or at least 0.3, or at least 0.4.

The particle diameter distribution of the porous particles may be monomodal, bimodal or multimodal. Preferably the particle diameter distribution is monomodal.

The porous particles may have an average sphericity (as defined herein) of more than 0.5. Preferably they have an average sphericity of at least 0.55, or at least 0.6, or at least 0.65, or at least 0.7, or at least 0.75, or at least 0.8, or at least 0.85. Preferably, the porous particles have an average sphericity of at least 0.90, or at least 0.92, or at least 0.93, or at least 0.94, or at least 0.95. Spherical particles are believed to aid uniformity of deposition and facilitate denser packing both in the batch pressure reactor and of the final product when incorporated into electrodes.

It is possible to obtain highly accurate two-dimensional projections of micron scale particles by scanning electron microscopy (SEM) or by dynamic image analysis, in which a digital camera is used to record the shadow projected by a particle. The term “sphericity” as used herein shall be understood as the ratio of the area of the particle projection (obtained from such imaging techniques) to the area of a circle, wherein the particle projection and circle have identical circumference. Thus, for an individual particle, the sphericity S may be defined as:

$$S = \frac{4 \cdot π \cdot {A}_{m}}{{( {C}_{m} )}^{2}}$$

wherein Aₘ is the measured area of the particle projection and Cₘ is the measured circumference of the particle projection. The average sphericity Sₐᵥ of a population of particles as used herein is defined as:

$${S}_{a ν} = \frac{1}{n} {\sum }_{i = 1}^{n} [ \frac{4 \cdot π \cdot {A}_{m}}{{( {C}_{m} )}^{2}} ]$$

wherein n represents the number of particles in the population. The average sphericity for a population of particles is preferably calculated from the two-dimensional projections of at least 50 particles.

The porous particles generally comprise a three-dimensionally interconnected open pore network comprising micropores and/or mesopores and optionally a minor volume of macropores. In accordance with conventional IUPAC terminology, the term “micropore” is used herein to refer to pores of less than 2 nm in diameter, the term “mesopore” is used herein to refer to pores of 2-50 nm in diameter, and the term “macropore” is used to refer to pores of greater than 50 nm diameter.

References herein to the volume of micropores, mesopores and macropores in the porous particles, and also any references to the distribution of pore volume within the porous particles, relate to the internal pore volume of the porous particles used as the starting material in step (a) of the claimed process, i.e. prior to deposition of electroactive material into the pore volume in step (b).

The porous particles may be characterised by the total volume of micropores and mesopores (i.e. the total pore volume in the pore diameter range from 0 to 50 nm). Typically, the porous particles include both micropores and mesopores. However, it is not excluded that porous particles may be used which include micropores and no mesopores, or mesopores and no micropores.

The total volume of micropores and mesopores in the porous particles is preferably at least 0.45 cm³/g, or at least 0.5 cm³/g, or at least 0.55 cm³/g, or at least 0.6 cm³/g, or at least 0.65 cm³/g, or at least 0.7 cm³/g, or at least 0.75 cm³/g, or at least 0.8 cm³/g. The use of higher porosity particles may be advantageous since it allows a larger amount of electroactive material to be accommodated within the pore volume.

The internal pore volume of the porous particles is suitably capped at a value at which increasing fragility of the particles structure outweighs the advantage of increased pore volume accommodating a larger amount of electroactive material. Preferably, the total volume of micropores and mesopores in the porous particles is no more than 2.0 cm³/g, or no more than 1.8 cm³/g, or no more than 1.7 cm³/g, or no more than 1.6 cm³/g, or no more than 1.55 cm³/g, or no more than 1.5 cm³/g, or no more than 1.45 cm³/g, or no more than 1.4 cm³/g, or no more than 1.35 cm³/g, or no more than 1.3 cm³/g, or no more than 1.25 cm³/g, or no more than 1.2 cm³/g, or no more than 1.15 cm³/g, or no more than 1.1 cm³/g.

Preferably the total volume of micropores and mesopores in the porous particles is in the range from 0.4 to 1.8 cm³/g, or from 0.4 to 1.7 cm³/g, or from 0.5 to 1.6 cm³/g, or from 0.5 to 1.55 cm³/g, or from 0.6 to 1.5 cm³/g, or from 0.6 to 1.45 cm³/g, or from 0.65 to 1.4 cm³/g, or from 0.65 to 1.35 cm³/g, or from 0.7 to 1.3 cm³/g, or from 0.7 to 1.25 cm³/g, or from 0.75 to 1.2 cm³/g, or from 0.75 to 1.1 cm³/g, or from 0.8 to 1.15 cm³/g, or from 0.8 to 1.1 cm³/g.

The term “particle diameter” as used herein refers to the equivalent spherical diameter (esd), i.e. the diameter of a sphere having the same volume as a given particle, wherein the particle volume is understood to include the volume of any intra-particle pores. The terms “Dₙ particle size” and “Dₙ particle diameter” as used herein refer to the nth percentile volume-based median particle diameter, i.e. the diameter below which n % by volume of the particle population is found. For instance, the terms “D₅₀” and “D₅₀ particle diameter” as used herein refer to the volume-based median particle diameter, i.e. the diameter below which 50% by volume of the particle population is found.

Particle diameters and particle diameter distributions can be determined by standard laser diffraction techniques in accordance with ISO 13320:2009. Laser diffraction relies on the principle that a particle will scatter light at an angle that varies depending on the size the particle and a collection of particles will produce a pattern of scattered light defined by intensity and angle that can be correlated to a particle diameter distribution. A number of laser diffraction instruments are commercially available for the rapid and reliable determination of particle diameter distributions. Unless stated otherwise, particle diameter distribution measurements as specified or reported herein are as measured by the conventional Malvern Mastersizer™ 3000 particle size analyzer from Malvern Instruments™. The Malvern Mastersizer™ 3000 particle size analyzer operates by projecting a helium-neon gas laser beam through a transparent cell containing the particles of interest suspended in an aqueous solution. Light rays which strike the particles are scattered through angles which are inversely proportional to the particle size and a photodetector array measures the intensity of light at several predetermined angles and the measured intensities at different angles are processed by a computer using standard theoretical principles to determine the particle diameter distribution. Laser diffraction values as reported herein are obtained using a wet dispersion of the particles in 2-propanol with a 5 vol % addition of the surfactant SPAN™-40 (sorbitan monopalmitate). The particle refractive index is taken to be 2.68 for porous particles and 3.50 for composite particles and the dispersant index is taken to be 1.378. Particle diameter distributions are calculated using the Mie scattering model.

The general term “PDₙ pore diameter” refers herein to the volume-based nth percentile pore diameter, based on the total volume of micropores and mesopores. For instance, the term “PD₅₀ pore diameter” as used herein refers to the pore diameter below which 50% of the total micropore and mesopore volume is found. For the avoidance of doubt, any macropore volume (pore diameter greater than 50 nm) is not taken into account for the purpose of determining PDₙ values.

The PD₅₀ pore diameter of the porous particles is preferably no more than 10 nm, or no more than 8 nm, or no more than 6 nm. More preferably the PD₅₀ pore diameter of the porous particles is no more than 5 nm, or no more than 4 nm, or no more than 3 nm, or no more than 2.5 nm, or no more than 2 nm, or no more than 1.9 nm, or no more than 1.8 nm, or no more than 1.7 nm, or no more than 1.6 nm.

The PD₉₀ pore diameter of the porous particles is preferably no more than 20 nm, or no more than 15 nm, or no more than 12 nm, or no more than 10 nm, or no more than 8 nm, or no more than 6 nm, or no more than 5 nm, or no more than 4 nm. Preferably, the PD₉₀ pore diameter of the porous particles is at least 1.5 nm, or at least 2 nm, or at least 3 nm, or at least 3.2 nm, or at least 3.5 nm, or at least 3.8 nm, or at least 4 nm. For example, the PD₉₀ pore diameter of the porous particles is preferably in the range from 1.5 to 20 nm, or from 2 to 20 nm, or from 3.2 to 20 nm, or from 3.5 to 15 nm, or from 3.8 to 10 nm, or from 4 to 8 nm, or from 1.5 to 5 nm, or from 2 to 5 nm, or from 3 to 5 nm.

The micropore volume fraction is preferably at least 0.35, or at least 0.4, or at least 0.45, or at least 0.5, or at least 0.55, or at least 0.6, or at least 0.61, based on the total volume of micropores and mesopores in the porous particles.

The micropore volume fraction is preferably no more than 0.98 or no more than 0.95, or no more than 0.90, or no more than 0.85, or no more than 0.8, or no more than 0.79 based on the total volume of micropores and mesopores in the porous particles.

Most preferably, the micropore volume fraction may be in the range from 0.35 to 0.98 or in the range from 0.4 to 0.95 or in the range from 0.4 to 0.90 or in the range from 0.4 to 0.85, or in the range from 0.45 to 0.85, or in the range from 0.5 to 0.8, or in the range from 0.55 to 0.8, or in the range from 0.6 to 0.8, or in the range from 0.61 to 0.79, based on the total volume of micropores and mesopores in the porous particles.

In certain other embodiments, the porous particles may be highly microporous, for example such that the micropore fraction is in the range from 0.7 to 0.98, or in the range from 0.7 to 0.95, or in the range from 0.8 to 0.98, or in the range from 0.35 to 0.55, or in the range from 0.35 to 0.5.

In certain other embodiments, the porous particles may have low microporosity, for example such that the micropore fraction is in the range from 0.3 to 0.6, or in the range from 0.35 to 0.55, or in the range from 0.4 to 0.5.

The pore diameter distribution of the porous particles may be monomodal, bimodal or multimodal. As used herein, the term “pore diameter distribution” relates to the distribution of pore diameter relative to the cumulative total internal pore volume of the porous particles. A bimodal or multimodal pore diameter distribution may be preferred since close proximity between micropores and pores of larger diameter provides the advantage of efficient ionic transport through the porous network to the electroactive material.

The total volume of micropores and mesopores and the pore diameter distribution of micropores and mesopores are determined using nitrogen gas adsorption at 77 K down to a relative pressure p/p₀ of 0.8×10⁻⁶ using quenched solid density functional theory (QSDFT) in accordance with standard methodology as set out in ISO 15901-2 and ISO 15901-3. Nitrogen gas adsorption is a technique that characterizes the porosity and pore diameter distributions of a material by allowing a gas to condense in the pores of a solid. As pressure increases, the gas condenses first in the pores of smallest diameter and the pressure is increased until a saturation point is reached at which all of the pores are filled with liquid. The nitrogen gas pressure is then reduced incrementally, to allow the liquid to evaporate from the system. Analysis of the adsorption and desorption isotherms, and the hysteresis between them, allows the pore volume and pore diameter distribution to be determined. Suitable instruments for the measurement of pore volume and pore diameter distributions by nitrogen gas adsorption include the Autosorb IQ porosity analyzers, which are available from Quantachrome Instruments.

Nitrogen gas adsorption is effective for the measurement of pore volume and pore diameter distributions for pores having a diameter up to 50 nm, but is less reliable for measuring a pore diameter distributions across a wider and higher range of pore diameters. For the purposes of the present invention, nitrogen adsorption is therefore used to determine pore volumes and pore diameter distributions only for pores having a diameter up to and including 50 nm (i.e. only for micropores and mesopores). PDₙ values are likewise determined relative to the total volume of micropores and mesopores only.

In view of the limitations of available analytical techniques it is not possible to measure pore volumes and pore diameter distributions across the entire range of micropores, mesopores and macropores using a single technique. In the case that the porous particles comprise macropores, the volume of pores having diameter in the range from greater than 50 nm and up to 100 nm may be measured by mercury porosimetry and is preferably no more than 0.3 cm³/g, or no more than 0.2 cm³/g, or no more than 0.1 cm³/g, or no more than 0.05 cm³/g. A small fraction of macropores may be useful to facilitate electrolyte access into the pore network, but the advantages of the invention are obtained substantially by accommodating electroactive material in micropores and smaller mesopores.

Any pore volume measured by mercury porosimetry at pore diameters of 50 nm or below is disregarded (as set out above, nitrogen adsorption is used to characterize the mesopores and micropores). Pore volume measured by mercury porosimetry above 100 nm is assumed for the purposes of the invention to be inter-particle porosity and is also disregarded.

Mercury porosimetry is a technique that characterizes the porosity and pore diameter distributions of a material by applying varying levels of pressure to a sample of the material immersed in mercury. The pressure required to intrude mercury into the pores of the sample is inversely proportional to the size of the pores. Values obtained by mercury porosimetry as reported herein are obtained in accordance with ASTM UOP578-11, with the surface tension y taken to be 480 mN/m and the contact angle q taken to be 140° for mercury at room temperature. The density of mercury is taken to be 13.5462 g/cm³ at room temperature. A number of high precision mercury porosimetry instruments are commercially available, such as the AutoPore IV series of automated mercury porosimeters available from Micromeritics Instrument Corporation, USA. For a complete review of mercury porosimetry reference may be made to P. A. Webb and C. Orr in “Analytical Methods in Fine Particle Technology, 1997, Micromeritics Instrument Corporation, ISBN 0-9656783-0.

It will be appreciated that intrusion techniques such as gas adsorption and mercury porosimetry are effective only to determine the pore volume of pores that are accessible to nitrogen or to mercury from the exterior of the porous particles. Porosity values specified herein shall be understood as referring to the volume of open pores, i.e. pores that are accessible to a fluid from the exterior of the porous particles. Fully enclosed pores which cannot be identified by nitrogen adsorption or mercury porosimetry shall not be taken into account herein when determining porosity values. Likewise, any pore volume located in pores that are so small as to be below the limit of detection by nitrogen adsorption is not taken into account.

The porous particles preferably have a BET surface area of at least 500 m²/g, or at least 750 m²/g, or at least 1,000 m²/g, or at least 1,250 m²/g, or at least 1,500 m²/g. The term “BET surface area” as used herein should be taken to refer to the surface area per unit mass calculated from a measurement of the physical adsorption of gas molecules on a solid surface, using the Brunauer-Emmett-Teller theory, in accordance with ISO 9277. Preferably, the BET surface area of the porous particles is no more than 4,000 m²/g, or no more than 3,500 m²/g, or no more than 3,250 m²/g, or no more than 3,000 m²/g or no more than 2,500 m²/g, or no more than 2,000 m²/g. For example, the porous particles may have a BET surface area in the range from 500 m²/g to 4,000 m²/g, or from 750 m²/g to 3,500 m²/g, or from 1,000 m²/g to 3,250 m²/g, or from 1,000 m²/g to 3,000 m²/g, or from 1,000 m²/g to 2,500 m²/g, or from 1,000 m²/g to 2,000 m²/g.

The porous particles preferably have a particle density of at least 0.35 and preferably less than 3 g/cm³, more preferably less than 2 g/cm³, more preferably less than 1.5 g/cm³, most preferably from 0.35 to 1.2 g/cm³. As used herein, the term “particle density” refers to “apparent particle density” as measured by mercury porosimetry (i.e. the mass of a particle divided by the particle volume wherein the particle volume is taken to be the sum of the volume of solid material and any closed or blind pores (a “blind pore” is pore that is too small to be measured by mercury porosimetry). Preferably, the porous particles have particle density of at least 0.4 g/cm³, or at least 0.45 g/cm³, or at least 0.5 g/cm³, or at least 0.55 g/cm³, or at least 0.6 g/cm³, or at least 0.65 g/cm³, or at least 0.7 g/cm³. Preferably, the porous particles have particle density of no more than 1.15 g/cm³, or no more than 1.1 g/cm³, or no more than 1.05 g/cm³, or no more than 1 g/cm³, or no more than 0.95 g/cm³, or no more than 0.9 g/cm³.

The porous particles preferably have a tap density of at least 0.3 g/cm³, or at least 0.35 g/cm³ or at least 0.4 g/cm³, or at least 0.5 g/cm³.

Preferably the porous particles have:
(i) a total pore volume of micropores and mesopores as measured by nitrogen gas adsorption in the range from 0.4 to 1.8 cm³/g;
(ii) a PD₅₀ pore diameter of no more than 4 nm, and preferably a PD₉₀ pore diameter of no more than 10 nm;
(iii) a D₅₀ particle diameter in the range from 1 to 20 μm;
(iv) a D₁ particle diameter of at least 1.0 μm; and
(v) a ratio D₅₀/D₁ of no more than 5.

More preferably the porous particles have:
(i) a total pore volume of micropores and mesopores as measured by nitrogen gas adsorption in the range from 0.5 to 1.6 cm³/g;
(ii) a PD₅₀ pore diameter of no more than 4 nm, and preferably a PD₉₀ pore diameter of no more than 10 nm;
(iii) a D₅₀ particle diameter in the range from 2 to 12 μm;
(iv) a D₁ particle diameter of at least 1.0 μm; and
(v) a ratio D₅₀/D₁ of no more than 4.

More preferably the porous particles have:
(i) a total pore volume of micropores and mesopores as measured by nitrogen gas adsorption in the range from 0.6 to 1.5 cm³/g;
(ii) a PD₅₀ pore diameter of no more than 3 nm, and preferably a PD₉₀ pore diameter of no more than 8 nm;
(iii) a D₅₀ particle diameter in the range from 2 to 12 μm;
(iv) a D₁ particle diameter of at least 1.0 μm
(v) a ratio D₅₀/D₁ of no more than 3.

More preferably the porous particles have:
(i) a total pore volume of micropores and mesopores as measured by nitrogen gas adsorption in the range from 0.65 to 1.4 cm³/g;
(ii) a PD₅₀ pore diameter of no more than 2.5 nm, and preferably a PD₉₀ pore diameter of no more than 8 nm;
(iii) a D₅₀ particle diameter in the range from 2 to 10 μm;
(iv) a D₁ particle diameter of at least 1.0 μm; and
(v) a ratio D₅₀/D₁ of no more than 3.

Preferably the porous particles have:
(i) a total pore volume of micropores and mesopores as measured by nitrogen gas adsorption in the range from 0.4 to 1.8 cm³/g;
(ii) a PD₅₀ pore diameter of no more than 4 nm, and preferably a PD₉₀ pore diameter of no more than 10 nm;
(iii) a D₅₀ particle diameter in the range from 1 to 20 μm;
(iv) a D₁ particle diameter of at least 1.0 μm;
(v) preferably a D₉₈ particle diameter of no more than 16 μm; and
(vi) a ratio D₉₈/D₁ of no more than 10.

More preferably the porous particles have:
(i) a total pore volume of micropores and mesopores as measured by nitrogen gas adsorption in the range from 0.5 to 1.6 cm³/g;
(ii) a PD₅₀ pore diameter of no more than 4 nm, and preferably a PD₉₀ pore diameter of no more than 10 nm;
(iii) a D₅₀ particle diameter in the range from 2 to 12 μm;
(iv) a D₁ particle diameter of at least 1.0 μm;
(v) preferably a D₉₈ particle diameter of no more than 16 μm; and
(vi) a ratio D₉₈/D₁ of no more than 8.

More preferably the porous particles have:
(i) a total pore volume of micropores and mesopores as measured by nitrogen gas adsorption in the range from 0.6 to 1.5 cm³/g;
(ii) a PD₅₀ pore diameter of no more than 3 nm, and preferably a PD₉₀ pore diameter of no more than 8 nm;
(iii) a D₅₀ particle diameter in the range from 2 to 10 μm;
(iv) a D₁ particle diameter of at least 1.0 μm;
(v) preferably a D₉₈ particle diameter of no more than 16 μm; and
(vi) a ratio D₉₈/D₁ of no more than 6.

Preferably the porous particles have:
(i) a total pore volume of micropores and mesopores as measured by nitrogen gas adsorption in the range from 0.4 to 1.8 cm³/g;
(ii) a PD₅₀ pore diameter of no more than 4 nm, and preferably a PD₉₀ pore diameter of no more than 10 nm;
(iii) a D₅₀ particle diameter in the range from 1 to 20 μm;
(iv) a D₁ particle diameter of at least 1.0 μm;
(v) preferably a D₉₈ particle diameter of no more than 16 μm; and
(vi) D₉₈−D₁ of no more than 15 μm.

More preferably the porous particles have:
(i) a total pore volume of micropores and mesopores as measured by nitrogen gas adsorption in the range from 0.5 to 1.6 cm³/g;
(ii) a PD₅₀ pore diameter of no more than 4 nm, and preferably a PD₉₀ pore diameter of no more than 10 nm;
(iii) a D₅₀ particle diameter in the range from 2 to 12 μm;
(iv) a D₁ particle diameter of at least 1.0 μm;
(v) preferably a D₉₈ particle diameter of no more than 16 μm; and
(vi) D₉₈−D₁ of no more than 13 μm.

More preferably the porous particles have:
(i) a total pore volume of micropores and mesopores as measured by nitrogen gas adsorption in the range from 0.6 to 1.5 cm³/g;
(ii) a PD₅₀ pore diameter of no more than 3 nm, and preferably a PD₉₀ pore diameter of no more than 8 nm;
(iii) a D₅₀ particle diameter in the range from 2 to 10 μm;
(iv) a D₁ particle diameter of at least 1.0 μm;
(v) preferably a D₉₈ particle diameter of no more than 16 μm; and
(vi) D₉₈−D₁ of no more than 12 μm.

More preferably the porous particles have:
(i) a total pore volume of micropores and mesopores as measured by nitrogen gas adsorption in the range from 0.7 to 1.3 cm³/g;
(ii) a PD₅₀ pore diameter of no more than 4 nm, and preferably a PD₉₀ pore diameter of no more than 8 nm;
(iii) a D₅₀ particle diameter in the range from 2 to 10 μm;
(iv) a D₁ particle diameter of at least 1.5 μm; and
(v) preferably a ratio D₅₀/D₁ of no more than 5.

More preferably the porous particles have:
(i) a total pore volume of micropores and mesopores as measured by nitrogen gas adsorption in the range from 0.75 to 1.2 cm³/g;
(ii) a PD₅₀ pore diameter of no more than 3 nm, and preferably a PD₉₀ pore diameter of no more than 6 nm;
(iii) a D₅₀ particle diameter in the range from 2 to 10 μm; and
(iv) a D₁ particle diameter of at least 1.8 μm; and
(v) preferably a ratio D₅₀/D₁ of no more than 4.

More preferably the porous particles have:
(i) a total pore volume of micropores and mesopores as measured by nitrogen gas adsorption in the range from 0.8 to 1.2 cm³/g;
(ii) a PD₅₀ pore diameter of no more than 2 nm, and preferably a PD₉₀ pore diameter of no more than 5 nm;
(iii) a D₅₀ particle diameter in the range from 2.5 to 8 μm; and
(iv) a D₁ particle diameter of at least 2 μm; and
(v) preferably a ratio D₅₀/D₁ of no more than 3.

More preferably the porous particles have:
(i) a total pore volume of micropores and mesopores as measured by nitrogen gas adsorption in the range from 0.7 to 1.3 cm³/g;
(ii) a PD₅₀ pore diameter of no more than 4 nm, and preferably a PD₉₀ pore diameter of no more than 8 nm;
(iii) a D₅₀ particle diameter in the range from 2 to 10 μm;
(iv) a D₁ particle diameter of at least 1.5 μm;
(v) preferably a D₉₈ particle diameter of no more than 16 μm; and
(vi) a ratio D₉₈/D₁ of no more than 10.

More preferably the porous particles have:
(i) a total pore volume of micropores and mesopores as measured by nitrogen gas adsorption in the range from 0.75 to 1.2 cm³/g;
(ii) a PD₅₀ pore diameter of no more than 3 nm, and preferably a PD₉₀ pore diameter of no more than 6 nm;
(iii) a D₅₀ particle diameter in the range from 2 to 10 μm;
(iv) a D₁ particle diameter of at least 1.8 μm;
(v) preferably a D₉₈ particle diameter of no more than 16 μm; and
(vi) a ratio D₉₈/D₁ of no more than 8.

More preferably the porous particles have:
(i) a total pore volume of micropores and mesopores as measured by nitrogen gas adsorption in the range from 0.8 to 1.2 cm³/g;
(ii) a PD₅₀ pore diameter of no more than 2 nm, and preferably a PD₉₀ pore diameter of no more than 5 nm;
(iii) a D₅₀ particle diameter in the range from 2.5 to 8 μm;
(iv) a D₁ particle diameter of at least 2 μm;
(v) preferably a D₉₈ particle diameter of no more than 16 μm; and
(vi) a ratio D₉₈/D₁ of no more than 6.

More preferably the porous particles have:
(i) a total pore volume of micropores and mesopores as measured by nitrogen gas adsorption in the range from 0.7 to 1.3 cm³/g;
(ii) a PD₅₀ pore diameter of no more than 4 nm, and preferably a PD₉₀ pore diameter of no more than 8 nm;
(iii) a D₅₀ particle diameter in the range from 2 to 10 μm;
(iv) a D₁ particle diameter of at least 1.5 μm;
(v) preferably a D₉₈ particle diameter of no more than 16 μm; and
(vi) a value of (D₉₈−D₁)/D₅₀ of no more than 2.

More preferably the porous particles have:
(i) a total pore volume of micropores and mesopores as measured by nitrogen gas adsorption in the range from 0.75 to 1.2 cm³/g;
(ii) a PD₅₀ pore diameter of no more than 3 nm, and preferably a PD₉₀ pore diameter of no more than 6 nm;
(iii) a D₅₀ particle diameter in the range from 2 to 10 μm;
(iv) a D₁ particle diameter of at least 1.8 μm;
(v) preferably a D₉₈ particle diameter of no more than 16 μm; and
(vi) a value of (D₉₈−D₁)/D₅₀ of no more than 2.

More preferably the porous particles have:
(i) a total pore volume of micropores and mesopores as measured by nitrogen gas adsorption in the range from 0.8 to 1.2 cm³/g;
(ii) a PD₅₀ pore diameter of no more than 2 nm, and preferably a PD₉₀ pore diameter of no more than 5 nm;
(iii) a D₅₀ particle diameter in the range from 2.5 to 8 μm;
(iv) a D₁ particle diameter of at least 2 μm;
(v) preferably a D₉₈ particle diameter of no more than 16 μm; and
(vi) a value of (D₉₈−D₁)/D₅₀ of no more than 1.8.

The step of providing a plurality of porous particles (step (a)) may comprise the steps of:
(i) providing a precursor population of porous particles comprising micropores and mesopores, wherein the micropores and mesopores have a total pore volume as measured by nitrogen gas adsorption of 0.4 to 2.0 cm³/g, and
(ii) classifying the precursor population of particles to obtain the plurality of porous particles as defined herein for use in step (a).

A suitable classifying apparatus is a dynamic air classifier, such as the Alpine TTD Ultra-Fine Air Classifier from Hosokawa Micron Powder Systems.

Optionally, the removal of fine particles is carried out in a separate step from the removal of oversized particles. Optionally, oversized particles may be removed by sieving.

The porous particles preferably have a flowability (ff_{c}) of at least 4, preferably at least 4.5, preferably at least 5, preferably at least 6, more preferably at least 7, wherein ff_{c} is defined as 01/0c, where 01 is the consolidation stress and σ_{c} is the unconfined yield strength, as measured using a Schulze ring shear tester, for example a Brookfield™ powder flow tester, according to ASTM-D6773-16, and wherein the flowability is measured at σ₁=5 kPa.

The flowability of the porous particles is closely related to the particle size distribution, since fine particles have a greater contribution to the cohesiveness of the particles than larger particles. Reducing the cohesiveness of the porous particles contributes directly to improved deposition of the electroactive material in the composite particle product by ensuring a homogenous distribution of the porous particles during the deposition process. Free movement of the porous particles within the CVI reactor ensures efficient and homogenous infiltration of the precursor into the pores of the porous particles. It furthermore ensures thermal homogeneity within the CVI reactor, ensuring controlled and uniform deposition of the electroactive material.

The porous particles preferably comprise a conductive material. The use of conductive porous particles is advantageous as the porous particles form a conductive framework within the composite particles which facilitates the flow of electrons between lithium atoms/ions inserted into the electroactive material and a current collector.

A preferred type of conductive porous particles are particles comprising or consisting of a conductive carbon-based material, referred to herein as conductive porous carbon particles.

The conductive porous carbon particles preferably comprise at least 80 wt % carbon, more preferably at least 85 wt % carbon, more preferably at least 90 wt % carbon, more preferably at least 95 wt % carbon, and optionally at least 98 wt % or at least 99 wt % carbon. The conductive porous carbon particles preferably have an ash content of no more than 0.5 wt %, more preferably no more than 0.4 wt %, or no more than 0.3 wt %, or no more than 0.2 wt %, or nor more than 0.15 wt %. The carbon may be crystalline carbon or amorphous carbon, or a mixture of amorphous and crystalline carbon. The porous carbon particles may be either hard carbon particles or soft carbon particles. Preferably the porous carbon particles are hard carbon particles.

As used herein, the term “hard carbon” refers to a disordered carbon matrix in which carbon atoms are found predominantly in the sp2 hybridised state (trigonal bonds) in nanoscale polyaromatic domains. The polyaromatic domains are cross-linked with a chemical bond, e.g. a C—O—C bond. Due to the chemical cross-linking between the polyaromatic domains, hard carbons cannot be converted to graphite at high temperatures. Hard carbons have graphite-like character as evidenced by the large G-band (˜1600 cm⁻¹) in the Raman spectrum. However, the carbon is not fully graphitic as evidenced by the significant D-band (˜1350 cm⁻¹) in the Raman spectrum.

As used herein, the term “soft carbon” also refers to a disordered carbon matrix in which carbon atoms are found predominantly in the sp2 hybridised state (trigonal bonds) in polyaromatic domains having dimensions in the range from 5 to 200 nm. In contrast to hard carbons, the polyaromatic domains in soft carbons are associated by intermolecular forces but are not cross-linked with a chemical bond. This means that they will graphitise at high temperature. The porous carbon particles preferably comprise at least 50% sp2 hybridised carbon as measured by XPS. For example, the porous carbon particles may suitably comprise from 50% to 98% sp2 hybridised carbon, from 55% to 95% sp2 hybridised carbon, from 60% to 90% sp2 hybridised carbon, or from 70% to 85% sp2 hybridised carbon.

Preferably the porous carbon particles have a ratio of the relative intensity of D and G band peaks (I_{D}/I_{G}) of ≤2.0 or ≤1.8 as measured by Raman spectroscopy. Preferably, I_{D}/I_{G} of the optimised particulate porous carbon frameworks may be ≥1 or ≥1.05. For example, I_{D}/I_{G} of the optimised particulate porous carbon frameworks may be in the range of 1.0 to 1.7, or in the range of 1.0 to 1.5. A higher I_{D}/I_{G} value represents a higher degree of disorder in the carbon structure.

A variety of different materials may be used to prepare suitable porous carbon particles via pyrolysis. Examples of organic materials that may be used include plant biomass including lignocellulosic materials (such as coconut shells, rice husks, hard and soft wood and products derived therefrom, including tree bark and sawdust etc.) and fossil carbon sources such as coal. Examples of resins and polymeric materials which form porous carbon particles on pyrolysis include phenolic resins, novolac resins, pitch, melamines, polyacrylates, polystyrenes, polyvinylalcohol (PVA), polyvinylpyrrolidone (PVP), and various copolymers comprising monomer units of acrylates, styrenes, α-olefins, vinyl pyrrolidone and other ethylenically unsaturated monomers. A variety of different carbon materials are available in the art depending on the starting material and the conditions of the pyrolysis process. Porous carbon particles of various different specifications are available from commercial suppliers.

Porous carbon particles may undergo a chemical or gaseous activation process to increase the volume of mesopores and micropores. A suitable activation process comprises contacting pyrolyzed carbon with one or more of oxygen, steam, CO, CO₂, boric acid and KOH at a temperature in the range from 600 to 1000° C.

Mesopores can also be obtained by known templating processes, using extractable pore formers such as MgO and other colloidal or polymer templates which can be removed by thermal or chemical means post pyrolysis or activation.

Alternatives to carbon-based conductive particles include porous particles comprising titanium nitride (TiN), titanium carbide (TIC), silicon carbide (SiC), nickel oxide (NiOx), titanium silicon nitride (TiSiN), nickel nitride (Ni₃N), molybdenum nitride (MoN), titanium oxynitride (TiOₓN₁₋ₓ), silicon oxide, silicon oxycarbide (SiOC), boron nitride (BN), or vanadium nitride (VN). Preferably the porous particles comprise titanium nitride (TIN), silicon oxycarbide (SiOC) or boron nitride (BN).

The electroactive material is preferably deposited via chemical vapor infiltration (CVI) of a gaseous precursor of the electroactive material into the pore structure of the porous particles. As used herein, CVI refers to processes in which a gaseous precursor is thermally decomposed on a surface to form the electroactive material at the surface and gaseous by-products. Accordingly, the precursor of the electroactive material is preferably a gaseous precursor. The term “gaseous precursor” shall be interpreted herein as referring a molecule that is thermally decomposable to form the electroactive material and which is in the vapour phase under the conditions of the deposition reaction.

The gaseous precursor in step (b) may be used either in pure form (or substantially pure form) or as a diluted mixture with an inert carrier gas, such as nitrogen or argon.

Preferably step (b) comprises contacting the porous particles with a gas comprising at least 30 vol %, or at least 40 vol %, or at least 50 vol %, or at least 60 vol %, or at least 70 vol %, or at least 80 vol %, or at least 90 vol %, or at least 95 vol %, or at least 97 vol %, or at least 99 vol % of precursor of the electroactive material based on the total volume of the gas.

The electroactive material deposited in step (b) is preferably selected from silicon, tin, germanium, aluminium and mixtures and alloys thereof. Preferably the electroactive material deposited in step (b) is silicon.

Suitable gaseous silicon-containing precursors include silane (SiH₄), disilane (Si₂H₆), trisilane (Si₃H₈), tetrasilane (Si₄H₁₀), methylsilane (CH₃SiH₃), dimethylsilane ((CH₃)₂SiH₂), or chlorosilanes such as trichlorosilane (HSiCl₃) or methylchlorosilanes such as methyltrichlorosilane (CH₃SiCl₃) or dimethyldichlorosilane ((CH₃)₂SiCl₂). Preferably the silicon-containing precursor is selected from the group consisting of silane (SiH₄), disilane (Si₂H₆), trisilane (Si₃H₈), tetrasilane (Si₄H₁₀). A particularly preferred precursor of silicon is silane.

Suitable precursors of tin include bis[bis(trimethylsilyl)amino]tin(II) ([[(CH₃)₃Si]₂N]₂Sn), tetraallyltin ((H₂C═CHCH₂)₄Sn), tetrakis(diethylamido)tin(IV) ([(C₂H₅)₂N]₄Sn), tetrakis(dimethylamido)tin(IV) ([(CH₃)₂N]₄Sn), tetramethyltin (Sn(CH₃)₄), tetravinyltin (Sn(CH═CH₂)₄), tin(II) acetylacetonate (C₁₀H₁₄O₄Sn), trimethyl(phenylethynyl)tin (C₆H₅C≡CSn(CH₃)₃), and trimethyl(phenyl)tin (C₆H₅Sn(CH₃)₃). A preferred precursor of tin is tetramethyltin.

Suitable precursors of aluminium include aluminium tris(2,2,6,6-tetramethyl-3,5-heptanedionate) (Al(OCC(CH₃)₃CHCOC(CH₃)₃)₃), trimethylaluminium ((CH₃)₃Al), and tris(dimethylamido)aluminium(II) (AI(N(CH₃)₂)₃). A preferred precursor of aluminium is trimethylaluminium.

Suitable precursors of germanium include germane (GeH₄), hexamethyldigermanium ((CH₃)₃GeGe(CH₃)₃), tetramethylgermanium ((CH₃)₄Ge), tributylgermanium hydride ([CH₃(CH₂)₃]₃GeH), triethylgermanium hydride ((C₂H₅)₃GeH), and triphenylgermanium hydride ((C₆H₅)₃GeH). A preferred precursor of germanium is germane.

In the case that the precursor is a chlorinated compound, such as a chlorosilane, the precursor is used in admixture with hydrogen gas, preferably in at least a 1:1 atomic ratio of hydrogen to chlorine.

Optionally, the precursor is free of chlorine. Free of chlorine means that the precursor contains less than 1 wt %, preferably less than 0.1 wt %, preferably less than 0.01 wt % of chlorine-containing compounds.

The presence of oxygen in step (b) should be avoided to prevent undesired oxidation of the deposited electroactive material, in accordance with conventional procedures for working in an inert atmosphere. Preferably, the oxygen content is less than 0.01 vol %, more preferably less than 0.001 vol % based on the total volume of gas used in step (b).

The temperature in step (b) is preferably in the range from 340 to 500° C., or from 350 to 480° C., or from 350 to 450° C., or from 350 to 420° C., or from 350 to less than 400° C., or from 355 to 395° C., or from 360 to 390° C., or from 360 to 385° C., or from 360 to 380° C.

The pressure in step (b) is preferably in the range from 1 to 5000 kPa.

Optionally, the pressure in step (b) is from 20 to 500 kPa, or from 40 to 200 kPa, or from 50 to 150 kPa, or from 60 to 120 kPa, or from 80 to 100 kPa. Preferably, the pressure in at step (b) is maintained at no more than 200 kPa, or at no more than 150 kPa, or at no more than 120 kPa, or at no more than 110 kPa, or at no more than 100 kPa, or at no more than 90 kPa, or at no more than 80 kPa.

More preferably, the pressure in step (b) is in the range from 50 to 15000 kPa, or from 100 to 10000 kPa, or from 150 to 5000 kPa, or from 200 to 2000 kPa, or from 500 to 1800 kPa, or from 800 to 1500 kPa, or from 1000 to 1400 kPa.

References to the pressure in any step of the claimed process refer to the absolute pressure in the reaction zone, which may comprise any suitable form of reactor vessel.

The deposition of electroactive materials by CVI results in the elimination of by-products, particularly by-product gases such as hydrogen. Step (b) preferably further comprises the separation of by-products from the particles formed in step (b). Separation of by-products may be effected by flushing the reactor with an inert gas and/or by evacuating the reactor by reducing the pressure. For example, the separation of by-products from the particles formed in step (b) may be effected by evacuating the reactor to a pressure of less than 100 kPa, or less than 80 kPa, or less than 60 kPa, or less than 40 kPa, or less than 20 kPa, or less than 10 kPa, or less than 5 kPa, or less than 2 kPa, or less than 1 kPa. Evacuating the reactor to low pressure may be effective not only to remove by-products in the gas phase, but also to desorb any by-products that may be adsorbed onto the surfaces of the deposited silicon.

The composite particles obtained according to the method of the invention preferably comprise at least 26 wt % of the electroactive material, or at least 28 wt % of the electroactive material, or at least 30 wt % of the electroactive material, or at least 32 wt % of the electroactive material, or at least 34 wt % of the electroactive material, or at least 36 wt % of the electroactive material, or at least 38 wt % of the electroactive material, or at least 40 wt % of the electroactive material, or at least 42 wt % of the electroactive material, or at least 44 wt % of the electroactive material. Preferably, the electroactive material is silicon.

The amount of electroactive material (e.g. silicon) in the composite particles is preferably selected such that at least 20% and up to 90% of the internal pore volume of the porous particles is occupied by the electroactive material following step (c). For example, the electroactive material may occupy from 20% to 80%, or from 25% to 75%, or from 30% to 70%, or from 35 to 65%, or from 40 to 60%, or from 45% to 55% of the internal pore volume of the porous particles. Within these preferred ranges, the remaining pore volume of the porous particles is effective to accommodate expansion of the electroactive material during charging and discharging, without a large excess pore volume which does not contribute to the volumetric capacity of the particulate particles. However, the amount of electroactive material is also not so high as to impede effective lithiation due to inadequate metal-ion diffusion rates or due to inadequate expansion volume resulting in mechanical resistance to lithiation.

In the case that the electroactive material is silicon, the amount of silicon in the composite particles can be related to the available pore volume in the porous particles by the requirement that the mass ratio of silicon to the porous particles is in the range from [0.5×P¹ to 1.9×P¹]:1, wherein P¹ is a dimensionless quantity having the magnitude of the total pore volume of micropores and mesopores in the porous particles, as expressed in cm³/g (e.g. if the porous particles have a total volume of micropores and mesopores of 1.2 cm³/g, then P¹=1.2). This relationship takes into account the density of silicon and the pore volume of the porous particles to define a weight ratio of silicon at which the pore volume is around 20% to 82% occupied. Preferably, the weight ratio of silicon deposited in step (b) to the porous particles is in the range from [0.6×P¹ to 1.8×P¹]:1 or from [0.7×P¹ to 1.7×P¹]:1, or from [0.8×P¹ to 1.6×P¹]:1.

The amount of silicon in the composite particles can be determined by elemental analysis. Preferably, elemental analysis is used to determine the elemental composition of the porous particles alone and the composition of the composite particles.

Silicon content is preferably determined by ICP-OES (Inductively coupled plasma-optical emission spectrometry). A number of ICP-OES instruments are commercially available, such as the iCAP® 7000 series of ICP-OES analysers available from ThermoFisher Scientific. The carbon content of the composite particles and of the porous carbon particles alone (as well as the hydrogen, nitrogen and oxygen content if required) are preferably determined by IR absorption. A suitable instrument for determining carbon, hydrogen, nitrogen and oxygen content is the TruSpec® Micro elemental analyser available from Leco Corporation.

Preferably at least 90 wt %, more preferably at least 95 wt %, even more preferably at least 98 wt % of the electroactive material in the composite particles is located within the internal pore volume of the porous particles such that there is no or very little electroactive material located on the external surfaces of the composite particles. As discussed above, deposition of electroactive material in a CVI process occurs at the surfaces of the porous particles. In view of the very high internal surface area of the porous particles, the reaction kinetics of the CVI process ensure that deposition of the electroactive material occurs almost entirely within the pores of the porous particles.

The internal deposition of the electroactive material is further improved by the requirement that the pressure in step (b) is maintained at less than 200 kPa, or within the more preferred pressure ranges discussed above.

The process of the invention optionally further comprises the step of:
(c) subjecting the particles from step (b) to heat treatment at a temperature of at least 400° C. and in the presence of an inert gas.

The heat treatment in step (c) is thought to promote the elimination of hydrogen and the solid-state rearrangement of the electroactive material (e.g. silicon) atoms, thereby reducing the density of unstable and reactive M—H bonds and promoting the formation of more thermodynamically stable M-M bonds (where M=the electroactive material, e.g. Si, Sn, Al, Ge, etc.). This is believed to contribute to improved stability of the electroactive material during charging and discharging and therefore to an improvement in the cycle life of metal-ion batteries comprising the composite particles.

The temperature in step (c) is generally greater than the temperature in step (b). Preferably, the temperature in step (c) is at least 20° C., or at least 40° C., or at least 60° C., or at least 80° C., or at least 100° C., or at least 120° C., or at least 140° C., or at least 150° C. greater than the temperature in step (b).

Step (c) is carried out in the presence of an inert gas. An inert gas refers herein to any gas that does not undergo reaction under the conditions of step (c). Preferably, the inert gas is selected from nitrogen and the noble gases, in particular argon. Optionally, the inert gas may comprise hydrogen. The inert gas may be selected from the group consisting of nitrogen, argon, helium and combinations thereof. Step (c) may be carried out in the presence of hydrogen and a gas selected from the group consisting of nitrogen, argon, helium and combinations thereof.

The process of the invention optionally further comprises the step of:
(d) contacting the surface of the particles from step (b) or step (c) with a passivating agent.

In the case that the process of the invention includes step (c), step (d) may be carried out before or after step (c).

As defined herein, a passivating agent is a compound of mixture of compounds which is able to react with the surface of the silicon deposited in step (b) to form a modified surface. In particular, a passivating agent as defined herein is a material which is able to react with the surfaces of the electroactive material to further reduce the surface energy thereof.

Preferably, step (d) is carried out after step (c). One effect of step (c) is to reopen pore spaces that were previously obstructed or capped by electroactive material nanostructures, such that the pore spaces are accessible to passivating gases, thus allowing for a more extensive passivation of the electroactive material surfaces and the reduction or elimination of hydrogen-terminated electroactive material surfaces.

One type of passivation layer is a native oxide layer. A native oxide layer may be formed, for example, by exposing the electroactive material surface to a passivating agent selected from air or another oxygen containing gas, for example, water vapour or CO₂. The passivation layer may comprise an oxide of the formula MOₓ, wherein 0<x≤2. The oxide is preferably amorphous. The formation of a native oxide layer is exothermic and therefore requires careful process control to prevent overheating or even combustion of the particulate material. In the case that the passivating agent is an oxygen-containing gas, step (c) may comprise cooling the material formed in step (b) to a temperature below 300° C., preferably below 200° C., optionally below 100° C., prior to contacting the electroactive material surfaces with the oxygen containing gas.

Another type of passivation layer is a nitride layer that is formed, for example, by exposing the electroactive material surfaces to a passivating agent selected from ammonia or another nitrogen containing molecule. The passivation layer may comprise a nitride of the formula MNₓ, wherein 0<x≤4/3. The nitride is preferably amorphous. A nitride layer may be formed by contacting the electroactive material surfaces with ammonia at a temperature in the range from 200-700° C., preferably from 400-700° C., more preferably from 400-600° C. The temperature may then be increased if necessary into the range of 500 to 1,000° C. to form a nitride surface. Nitride passivation may be preferred to oxide passivation. As sub-stoichiometric nitrides (such as SiNₓ, wherein 0<x≤4/3) are conductive, nitride passivation layers may function as a conductive network that allows for faster charging and discharging of the electroactive material. Phosphine may also be used as a passivating agent, as a phosphorus analog of ammonia.

Another type of passivation layer is an oxynitride layer that is formed, for example, by exposing the electroactive material surfaces to a passivating agent comprising ammonia (or another nitrogen containing molecule) and oxygen gas. The passivation layer may comprise a electroactive material oxynitride of the formula MOₓN_{y}, wherein 0<x<2, 0<y<4/3, and 0<(2x+3y)≤4). The oxynitride is preferably amorphous.

Another type of passivation layer is a carbide layer. The passivation layer may comprise a carbide of the formula MCₓ, wherein 0<x≤1. The carbide is preferably amorphous. A carbide layer may be formed by contacting the electroactive material surfaces with a passivating agent selected from carbon containing precursors, e.g. methane or ethylene at elevated temperatures, e.g in the range from 250 to 700° C. At lower temperatures, covalent bonds are formed between the electroactive material surfaces and the carbon-containing precursors, which are the converted to a monolayer of crystalline carbide as the temperature is increased. The carbide may comprise a silicon carbide of the formula SiCx, wherein 0<x≤1.

Other suitable passivating agents include compounds comprising an alkene, alkyne or carbonyl functional group, more preferably a terminal alkene, terminal alkyne, aldehyde or ketone group.

Preferred passivating agents include one or more compounds of the formulae:

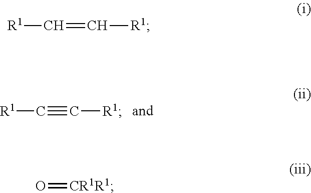

wherein each R¹ independently represents H or an unsubstituted or substituted aliphatic or aromatic hydrocarbyl group having from 1 to 20 carbon atoms, or wherein two R¹ groups form an unsubstituted or substituted ring structure comprising from 3 to 8 carbon atoms in the ring.

Particularly preferred passivating agents include one or more compounds of the formulae:

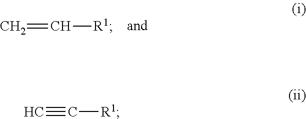

wherein R¹ is as defined above. Preferably, R¹ is unsubstituted.

Examples of suitable passivating agents include ethylene, propylene, 1-butene, butadiene, 1-pentene, 1,4-pentadiene, 1-hexene, 1-octene, styrene, divinylbenzene, acetylene, phenylacetylene, norbornene, norbornadiene and bicyclo[2.2.2]oct-2-ene. Optionally, mixtures of different passivating agents may also be used.

It is believed that passivating agents comprising an alkene, alkyne or carbonyl group undergo an insertion reaction with M—H groups (e.g. Si—H groups) at the silicon surface to form a covalently passivated surface which is resistant to oxidation by air. For example, the passivation reaction between a silicon surface and the passivating agent may therefore be understood as a form of hydrosilylation, as shown schematically below.

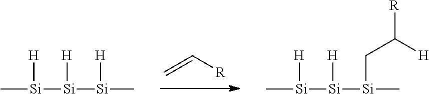

Other suitable passivating agents include compounds including an active hydrogen atom bonded to oxygen, nitrogen, sulphur or phosphorus. For example, the passivating agent may be an alcohol, amine, thiol or phosphine. Reaction of the group —XH with hydride groups at the electroactive material surfaces is understood to result in elimination of H₂ and the formation of a direct bond between X and the electroactive material surfaces.

Suitable passivating agents in this category include compounds of the formula

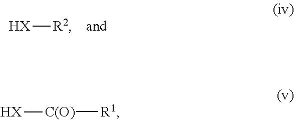

wherein X represents O, S, NR¹ or PR¹; each R¹ is independently as defined above; and R² represents an unsubstituted or substituted aliphatic or aromatic hydrocarbyl group having from 1 to 20 carbon atoms, or R¹ and R² together form an unsubstituted or substituted ring structure comprising from 3 to 8 carbon atoms in the ring.

Preferably X represents O or NH.

Preferably R² represents an optionally substituted aliphatic or aromatic group having from 2 to 10 carbon atoms. Amine groups may also be incorporated into a 4-10 membered aliphatic or aromatic ring structure, as in pyrrolidine, pyrrole, imidazole, piperazine, indole, or purine.

Contacting of the electroactive material with the passivating agent in step (d) may be carried out at a temperature in the range of 25 to 500° C., preferably at a temperature in the range of from 50 to 450° C., more preferably from 100 to 400° C.

The process of the invention optionally further comprises the step of:
(e) depositing a lithium ion permeable material into the pores and/or onto the outer surface of the composite particles from step (b), (c) or step (d).

In the case that the process of the invention includes step (c) and/or step (d), steps (c) (d) and (e) may be carried out in any order. In the case that step (c) is included, step (e) is preferably carried out after step (c). In the case that step (d) is included, step (e) is preferably carried out after step (d). In the case that steps (c) and (d) are included, step (e) is preferably carried out after step (d).

Preferably, the lithium-ion permeable material is a pyrolytic carbon material and step (e) comprises combining the particles from step (b), (c) or step (d) with a pyrolytic carbon precursor; and heating the pyrolytic carbon precursor to a temperature effective to cause the deposition of a conductive pyrolytic carbon material into the pores and/or onto the outer surface of the composite particles.

The pyrolytic carbon precursor is preferably a hydrocarbon. Suitable hydrocarbons include polycyclic hydrocarbons comprising from 10 to 25 carbon atoms and optionally from 1 to 3 heteroatoms, optionally wherein the polyaromatic hydrocarbon is selected from naphthalene, substituted naphthalenes such as di-hydroxynaphthalene, anthracene, tetracene, pentacene, fluorene, acenapthene, phenanthrene, fluoranthrene, pyrene, chrysene, perylene, coronene, fluorenone, anthraquinone, anthrone and alkyl-substituted derivatives thereof. Suitable pyrolytic carbon precursors also include bicyclic monoterpenoids, optionally wherein the bicyclic monoterpenoid is selected from camphor, borneol, eucalyptol, camphene, careen, sabinene, thujene and pinene. Further suitable pyrolytic carbon precursors include C₂-C₁₀ hydrocarbons, optionally wherein the hydrocarbons are selected from alkanes, alkenes, alkynes, cycloalkanes, cycloalkenes, and arenes, for example methane, ethylene, propylene, limonene, styrene, cyclohexane, cyclohexene, α-terpinene and acetylene. Other suitable pyrolytic carbon precursors include phthalocyanine, sucrose, starches, graphene oxide, reduced graphene oxide, pyrenes, perhydropyrene, triphenylene, tetracene, benzopyrene, perylenes, coronene, and chrysene. A preferred carbon precursor is acetylene.

A suitable temperature for the deposition of a pyrolytic carbon material in step (e) is in the range from 300 to 800° C., or from 400 to 700° C. For example, the temperature may be no more than 680° C. or no more than 660° C., or no more than 640° C. or no more than 620° C., or no more than 600° C., or no more than 580° C., or no more than 560° C., or no more than 540° C., or no more than 520° C., or no more than 500° C. The minimum temperature will depend on the type of carbon precursor that is used.

Preferably, the temperature is at least 300° C., or at least 350° C., or at least 400° C., or at least 450° C., or at least 500° C.

The carbon-containing precursors used in step (e) may be used in pure form, or diluted mixture with an inert carrier gas, such as nitrogen or argon. For instance, the carbon-containing precursor may be used in an amount in the range from 0.1 to 100 vol %, or 0.5 to 20 vol %, or 1 to 10 vol %, or 1 to 5 vol % based on the total volume of the precursor and the inert carrier gas.

In the case that a pyrolytic carbon material is deposited in step (e), the same compound may function as both a passivating agent in step (d) and the pyrolytic carbon precursor in step (e). For example, if styrene is selected as the pyrolytic carbon precursor, then it will also function as a passivating agent if the particles from step (b) are not exposed to another passivating agent prior to contact with styrene. In this case, passivation and deposition of the conductive carbon material in steps may be carried out simultaneously, for example at a temperature in the range of from 300-700° C. Alternatively, passivation and deposition of the conductive carbon material may be carried out sequentially, with the same material as the passivating agent and the pyrolytic carbon precursor, but wherein step (e) is carried out at a higher temperature than, and following, the passivation in step (d). For example, passivation in step (d) may be carried out at a temperature in the range of from 25° C. to less than 300° C., and deposition of pyrolytic carbon may be carried out at a temperature in the range from 300-700° C. These two steps may suitably be carried out sequentially by increasing the temperature while maintaining contact with the compound that functions as both a passivating agent and the pyrolytic carbon precursor. At lower temperatures (e.g. in the range of 25° C. to <300° C.) passivation will be the primary process. As the temperature is increased (e.g. to 300-700° C.) the deposition of pyrolytic carbon will ensue.

The process the invention optionally further comprises the step of:
(f) subjecting the particles from step (b), (c), (d) or (e) to a deagglomeration step to reduce the presence of agglomerated particles.

The process of the invention optionally further comprises the step of:
(g) classifying the composite particles from step (b), (c), (d), (e) or (f) such that the classified particles have a D₁ particle diameter of at least 0.5 μm.

Classification of the composite particles may suitably be carried out by dynamic air classification as set out above. Alternative methods of classification may be used including hydroclassification, gravity separation or other known methods.

Composite particles obtained by the process of the invention can be characterised by their performance under thermogravimetric analysis (TGA) in air. This method of analysis relies on the principle that a weight gain is observed when electroactive materials are oxidized in air and at elevated temperature.

As defined herein, “surface silicon” is calculated from the initial mass increase in the TGA trace from a minimum between 150° C. and 500° C. to the maximum mass measured in the temperature range between 550° C. and 650° C., wherein the TGA is carried out in air with a temperature ramp rate of 10° C./min. This mass increase is assumed to result from the oxidation of surface silicon and therefore allows the percentage of surface silicon as a proportion of the total amount of silicon to be determined according to the following formula:

$$Y = 1.875 \times [ ( {M}_{ma x} - {M}_{m i n} ) / {M}_{f} ] \times 100 \%$$

Wherein Y is the percentage of surface silicon as a proportion of the total silicon in the sample, Mₘₐₓ is the maximum mass of the sample measured in the temperature range between 550° C. to 650° C., Mₘᵢₙ is the minimum mass of the sample above 150° C. and below 500° C., and M_{f} is the mass of the sample at completion of oxidation at 1400° C. For completeness, it will be understood that 1.875 is the molar mass ratio of SiO₂ to O₂ (i.e. the mass ratio of SiO₂ formed to the mass increase due to the addition of oxygen). Typically, the TGA analysis is carried out using a sample size of 10 mg±2 mg.

It has been found that reversible capacity retention over multiple charge/discharge cycles is considerably improved when the surface silicon as determined by the TGA method described above is at least 20 wt % of the total amount of silicon in the material. Preferably at least 22 wt %, or at least 25 wt %, at least 30 wt % of the silicon, or at least 35 wt % of the silicon, or at least 40 wt % of the silicon, or at least 45 wt % of the silicon is surface silicon as determined by thermogravimetric analysis (TGA).

In addition to the surface silicon content, the silicon-containing composite particles obtained by the process of the invention preferably have a low content of coarse bulk silicon as determined by TGA. Coarse bulk silicon is defined herein as silicon which undergoes oxidation above 800° C. as determined by TGA, wherein the TGA is carried out in air with a temperature ramp rate of 10° C./min. The coarse bulk silicon content is therefore determined according to the following formula:

$$Z = 1.875 \times [ ( {M}_{f} - {M}_{800} ) / {M}_{f} ] \times 100 \%$$

Wherein Z is the percentage of unoxidized silicon at 800° C., M₈₀₀ is the mass of the sample at 800° C., and M_{f} is the mass of ash at completion of oxidation at 1400° C. For the purposes of this analysis, it is assumed that any mass increase above 800° C. corresponds to the oxidation of silicon to SiO₂ and that the total mass at completion of oxidation is SiO₂.

Silicon that undergoes oxidation above 800° C. is less desirable. Preferably, no more than 10 wt %, or no more than 8 wt %, or no more than 6 wt %, or no more than 5 wt %, or no more than 4 wt %, or no more than 3 wt %, or no more than 2 wt %, or no more than 1.5 wt % of the silicon is coarse bulk silicon as determined by TGA.

Preferably, at least 30 wt % of the silicon is surface silicon and no more than 10 wt % of the silicon is coarse bulk silicon, wherein both are determined by TGA. More preferably, at least 35 wt % of the silicon is surface silicon and no more than 8 wt % of the silicon is coarse bulk silicon, wherein both are determined by TGA. More preferably, at least 40 wt % of the silicon is surface silicon and no more than 5 wt % of the silicon is coarse bulk silicon, wherein both are determined by TGA. More preferably, at least 45 wt % of the silicon is surface silicon and no more than 2 wt % of the silicon is coarse bulk silicon, wherein both are determined by TGA.

The composite particles obtained according to the process of the invention preferably have a BET surface area of no more than 100 m²/g, or no more than 80 m²/g, or no more than 60 m²/g, or no more than 40 m²/g, or no more than 30 m²/g, or no more than 25 m²/g, or no more than 20 m²/g, or no more than 15 m²/g, or no more than 10 m²/g, or no more than 5 m²/g. In general, a low BET surface area is preferred in order to minimize the formation of solid electrolyte interphase (SEI) layers at the surface of the composite particles during the first charge-discharge cycle of an anode. However, a BET surface area which is excessively low results in unacceptably low charging rate and capacity due to the inaccessibility of the bulk of the electroactive material to metal ions in the surrounding electrolyte. The BET surface area is preferably at least 0.1 m²/g, or at least 1 m²/g, or at least 2 m²/g, or at least 5 m²/g. For instance, the BET surface area of the composite particles may be in the range from 0.1 to 100 m²/g, or from 0.1 to 80 m²/g, or from 0.5 to 60 m²/g, or from 0.5 to 40 m²/g, or from 1 to 30 m²/g, or from 1 to 25 m²/g, or from 2 to 20 m²/g.

The process of the reaction may be carried out using any reactor that is capable of contacting solids and gases at elevated temperature. The porous particles and the forming composite particles are preferably present in the reactor in the form of an agitated bed of particles.

The second aspect of the invention provides a particulate material consisting of a plurality of composite particles, wherein the composite particles comprise:
(a) a porous particle framework comprising micropores and mesopores, wherein the micropores and mesopores have a total pore volume as measured by nitrogen gas adsorption of 0.4 to 2.0 cm³/g, and
(b) a plurality of nanoscale electroactive material domains located within the pores of the porous particle framework,
   wherein the composite particles have a D₁ particle diameter of at least 0.5 μm, a D₅₀ particle diameter in the range from 1 to 20 μm, and a BET surface area of no more than 50 m²/g.

Preferably, the D₁ particle diameter of the composite particles is at least 0.8 μm, or at least 1.0 μm, or at least 1.2 μm, or at least 1.4 μm, or at least 1.5 μm, or at least 1.6 μm, or at least 1.8 μm, or at least 2.0 μm, or at least 2.2 μm, or at least 2.4 μm, or at least 2.5 μm, or at least 2.6 μm, or at least 2.8 μm, or at least 3.0 μm.

In general, the composite particles have a D₅₀ particle diameter in the range from 1 to 20 μm. Preferably, the D₅₀ particle diameter of the composite particles is at least 1.5 μm, or at least 2 μm, or at least 2.5 μm, or at least 3 μm. Preferably, the D₅₀ particle diameter of the composite particles is no more than 18 μm, or no more than 15 μm, or no more than 12 μm, or no more than 10 μm, or no more than 8 μm. For example, the D₅₀ particle diameter of the composite particles may be in the range from 1.5 to 18 μm, or in the range from 1.5 to 15 μm, or in the range from 2 to 12 μm, or in the range from 2 to 10 μm, or in the range from 2.5 to 8 μm, or in the range from 3 to 8 μm.

The Do particle diameter of the composite particles is preferably no more than 30 μm, or no more than 25 μm, or no more than 20 μm, or no more than 18 μm, or no more than 16 μm, or no more than 15 μm, or no more than 12 μm.

Preferably, the D₁ particle diameter of the composite particles is in the range from 1.5. to 4.5 μm and the Do particle diameter is in the range from 9 to 15 μm, preferably wherein the D₁ particle diameter of the composite particles is in the range from 2 to 4 μm and the Do particle diameter is in the range from 10 to 14 μm, preferably wherein the D₁ particle diameter of the composite particles is in the range from 2.5 to 3.5 μm and the Do particle diameter is in the range from 11 to 13 μm.

The D₉₈ particle diameter of the composite particles is preferably no more than 35 μm, or no more than 30 μm, or no more than 25 μm, or no more than 20 μm, or no more than 18 μm, or no more than 16 μm, or no more than 15 μm, or no more than 12 μm.

The D₁₀₀ particle diameter of the composite particles is preferably no more than 40 μm, or no more than 35 μm, or no more than 30 μm, or no more than 25 μm, or no more than 20 μm.

Preferably, the difference between the D₉₈ particle diameter and the D₁ particle diameter of the composite particles (D₉₈−D₁) is no more than 18 μm, or no more than 16 μm, or no more than 15 μm, or no more than 14 μm, or no more than 13 μm, or no more than 12 μm.

Preferably, the ratio of the D₉₈ particle diameter to the D₁ particle diameter of the composite particles (D₉₈/D₁) is no more than 12, or no more than 10, or no more than 8, or no more than 6, or no more than 5.

Preferably, (D₉₈−D₁)/D₅₀ of the composite particles is no more than 2.2, or no more than 2, or no more than 1.9, or no more than 1.8, or no more than 1.7, or no more than 1.6.

Preferably, the difference between the Do particle diameter and the D₁ particle diameter of the composite particles (D₉₀−D₁) is no more than 12.0 μm, or no more than 10.0 μm, or no more than 9.0 μm, or no more than 8.0 μm.

Preferably, the ratio of the Do particle diameter to the D₁ particle diameter of the composite particles (D₉₀/D₁) is no more than 12.0, or no more than 10.0, or no more than 9.0, or no more than 8.0, or no more than 6.0, or no more than 5.0.

Preferably, (D₉₀−D₁)/D₅₀ of the composite particles is no more than 2.2, or no more than 2, or no more than 1.9, or no more than 1.8, or no more than 1.7, or no more than 1.6.

The composite particles preferably have a narrow particle diameter distribution span. For instance, the particle diameter distribution span (defined as (D₉₀−D₁₀)/D₅₀) is preferably 3 or less, more preferably 2 or less, and most preferably 1.5 or less. By maintaining a narrow particle diameter distribution span, efficient packing of the particles into dense powder beds is more readily achievable.

The ratio of the D₅₀ particle diameter to the D₁ particle diameter of the composite particles is preferably no more than 10.0, or no more than 8.0, or no more than 7.0, or no more than 6.0, or no more than 5.0, or no more than 4.0, or no more than 3.0. For example, the ratio of the D₅₀ particle diameter to the D₁ particle diameter of the composite particles in the range from 2.0 to 10.0, or from 2.0 to 8.0, or from 2.0 to 5.0.

The ratio of the D₁₀₀ particle diameter to the D₅₀ particle diameter of the composite particles is preferably no more than 3, or no more than 2.5 or no more than 2.

Preferred composite particles include those in which the D₁ particle diameter is at least 1.0 μm and the ratio of the D₅₀ particle diameter to the D₁ particle diameter is no more than 5, or no more than 4, or no more than 3.

Preferred composite particles also include those in which the D₁ particle diameter is at least 1.0 μm and the ratio of the Do particle diameter to the D₁ particle diameter of the composite particles (D₉₀/D₁) is no more than 9.0, or no more than 8.0, or no more than 7.0, or no more than 6.0, or no more than 5.0.

Preferred composite particles also include those in which the D₁ particle diameter is at least 1.0 μm and the difference between the Do particle diameter and the D₁ particle diameter of the composite particles (D₉₀−D₁) is no more than 10.0 μm, or no more than 9 μm, or no more than 8 μm.

Preferred composite particles also include those in which the D₁ particle diameter is at least 1.0 μm and the ratio of the D₉₈ particle diameter to the D₁ particle diameter of the composite particles (D₉₈/D₁) is no more than 10, or no more than 8.

Preferred composite particles also include those in which the D₁ particle diameter is at least 1.0 μm and the difference between the D₉₈ particle diameter and the D₁ particle diameter of the composite particles (D₉₈−D₁) is no more than 15 μm, or no more than 14 μm, or no more than 13 μm, or no more than 12 μm.

Preferred composite particles also include those in which the D₁ particle diameter is at least 1.0 μm and (D₉₈−D₁)/D₅₀ of the composite particles is no more than 2, or no more than 1.9, or no more than 1.8, or no more than 1.7, or no more than 1.6.

Preferred composite particles include those in which the D₁ particle diameter is at least 1.5 μm and the ratio of the D₅₀ particle diameter to the D₁ particle diameter is no more than 6.0, or no more than 5.0, or no more than 4.0, or no more than 3.0.

Preferred composite particles also include those in which the D₁ particle diameter is at least 1.5 μm and the ratio of the Do particle diameter to the D₁ particle diameter of the composite particles (D₉₀/D₁) is no more than 10.0, or no more than 9.0, or no more than 8.0, or no more than 7.0, or no more than 6.0, or no more than 5.0.

Preferred composite particles also include those in which the D₁ particle diameter is at least 1.5 μm and the difference between the Do particle diameter and the D₁ particle diameter of the composite particles (D₉₀−D₁) is no more than 10.0 μm, or no more than 9.0 μm, or no more than 8.0 μm.

Preferred composite particles also include those in which the D₁ particle diameter is at least 1.5 μm and the ratio of the D₉₈ particle diameter to the D₁ particle diameter of the composite particles (D₉₈/D₁) is no more than 12, or no more than 10, or no more than 8.

Preferred composite particles also include those in which the D₁ particle diameter is at least 1.5 μm and the difference between the D₉₈ particle diameter and the D₁ particle diameter of the composite particles (D₉₈−D₁) is no more than 18 μm, or no more than 16 μm, or no more than 15 μm, or no more than 14 μm, or no more than 13 μm, or no more than 12 μm.

Preferred composite particles also include those in which the D₁ particle diameter is at least 1.5 μm and (D₉₈−D₁)/D₅₀ of the composite particles is no more than 2, or no more than 1.9, or no more than 1.8, or no more than 1.7, or no more than 1.6.

The composite particles preferably have a positive skew in the volume-based particle diameter distribution. Preferably, the D₅₀ diameter is less than the volume-based mean particle diameter. Preferably, the skew of the composite particle diameter distribution (as measured by a Malvern Mastersizer™ 3000 analyzer) is no more than 4, or no more than 3, or no more than 2, or no more than 1.5. Preferably, the skew is at least 0.2, or at least 0.3, or at least 0.4. The particle diameter distribution of the composite particles may be monomodal, bimodal or multimodal. Preferably it is monomodal.

The composite particles may have an average sphericity (as defined herein) of more than 0.5. Preferably they have an average sphericity of at least 0.55, or at least 0.6, or at least 0.65, or at least 0.7, or at least 0.75, or at least 0.8, or at least 0.85. Preferably, the composite particles have an average sphericity of at least 0.90, or at least 0.92, or at least 0.93, or at least 0.94, or at least 0.95.

The total pore volume of micropores and mesopores in the porous particle framework is preferably at least 0.45 cm³/g, or at least 0.5 cm³/g, or at least 0.55 cm³/g, or at least 0.6 cm³/g, or at least 0.65 cm³/g, or at least 0.7 cm³/g, or at least 0.75 cm³/g, or at least 0.8 cm³/g. Preferably, the total pore volume of micropores and mesopores in the porous particle framework is no more than 1.8 cm³/g, or no more than 1.7 cm³/g, or no more than 1.6 cm³/g, or no more than 1.55 cm³/g, or no more than 1.5 cm³/g, or no more than 1.45 cm³/g, or no more than 1.4 cm³/g, or no more than 1.35 cm³/g, or no more than 1.3 cm³/g, or no more than 1.25 cm³/g, or no more than 1.2 cm³/g, or no more than 1.15 cm³/g, or no more than 1.1 cm³/g.

Preferably the total volume of micropores and mesopores in the porous particle framework is in the range from 0.4 to 1.8 cm³/g, or from 0.4 to 1.7 cm³/g, or from 0.5 to 1.6 cm³/g, or from 0.5 to 1.55 cm³/g, or from 0.6 to 1.5 cm³/g, or from 0.6 to 1.45 cm³/g, or from 0.65 to 1.4 cm³/g, or from 0.65 to 1.35 cm³/g, or from 0.7 to 1.3 cm³/g, or from 0.7 to 1.25 cm³/g, or from 0.75 to 1.2 cm³/g, or from 0.75 to 1.1 cm³/g, or from 0.8 to 1.15 cm³/g, or from 0.8 to 1.1 cm³/g.

The PD₅₀ pore diameter of the porous particle framework is preferably no more than 10 nm, or no more than 8 nm, or no more than 6 nm, or no more than 5 nm, or no more than 4 nm, or no more than 3 nm, or no more than 2.5 nm, or no more than 2 nm, or no more than 1.9 nm, or no more than 1.8 nm, or no more than 1.7 nm, or no more than 1.6 nm.

The PD₉₀ pore diameter of the porous particle framework is preferably no more than 20 nm, or no more than 15 nm, or no more than 12 nm, or no more than 10 nm, or no more than 8 nm, or no more than 6 nm, or no more than 5 nm. Preferably, the PD₉₀ pore diameter of the porous particle framework is at least 3.2 nm, or at least 3.5 nm, or at least 3.8 nm, or at least 4 nm. For example, the PD₉₀ pore diameter of the porous particle framework is preferably in the range from 3.2 to 20 nm, or from 3.5 to 15 nm, or from 3.8 to 10 nm, or from 4 to 8 nm.

The micropore volume fraction of the porous particle framework is preferably at least 0.4, or at least 0.45, or at least 0.5, or at least 0.55, or at least 0.6, based on the total volume of micropores and mesopores.

The micropore volume fraction of the porous particle framework is preferably no more than 0.85, or no more than 0.8 based on the total volume of micropores and mesopores.

The pore diameter distribution of the porous particle framework may be monomodal, bimodal or multimodal.

The porous particle framework may have a BET surface area in the range from 100 m²/g to 4,000 m²/g, or from 500 m²/g to 4,000 m²/g, or from 750 m²/g to 3,500 m²/g, or from 1,000 m²/g to 3,250 m²/g, or from 1,000 m²/g to 3,000 m²/g, or from 1,000 m²/g to 2,500 m²/g, or from 1,000 m²/g to 2,000 m²/g.

For the avoidance of doubt, references herein to the pore volume, pore diameter distribution and the BET surface area of the of the porous particle framework relate to the porous particle framework as measured in isolation, i.e. in the absence of an electroactive material or any other material occupying the pores of the porous particle framework.

The porous particle framework preferably comprises a conductive material. A preferred type of conductive porous particle framework comprises or consists of a conductive carbon material. A conductive porous carbon particle framework preferably comprises at least 80 wt % carbon, more preferably at least 85 wt % carbon, more preferably at least 90 wt % carbon, more preferably at least 95 wt % carbon, and optionally at least 98 wt % or at least 99 wt % carbon. The carbon may be crystalline carbon or amorphous carbon, or a mixture of amorphous and crystalline carbon. The porous carbon particle framework may be either hard carbon or soft carbon.

The porous carbon particle framework may comprise any of the materials described herein for the porous particles used according to the first aspect of the invention.

The composite particles of the invention are suitably obtainable via chemical vapor infiltration (CVI) of a gaseous precursor of the electroactive material into the pore structure of the porous particles.

The electroactive material is preferably selected from silicon, tin, germanium, aluminium and mixtures and alloys thereof. Preferably the electroactive material is silicon.

The composite particles preferably comprise at least 26 wt % of the electroactive material, or at least 28 wt % of the electroactive material, or at least 30 wt % of the electroactive material, or at least 32 wt % of the electroactive material, or at least 34 wt % of the electroactive material, or at least 36 wt % of the electroactive material, or at least 38 wt % of the electroactive material, or at least 40 wt % of the electroactive material, or at least 42 wt % of the electroactive material, or at least 44 wt % of the electroactive material.

The amount of electroactive material (e.g. silicon) in the composite particles is preferably selected such that at least 20% and up to 90% of the internal pore volume of the porous particle framework is occupied by the electroactive material following step (c). For example, the electroactive material may occupy from 20% to 80%, or from 25% to 75%, or from 30% to 70%, or from 35 to 65%, or from 40 to 60%, or from 45% to 55% of the internal pore volume of the porous particle framework.

In the case that the electroactive material is silicon, the amount of silicon in the composite particles can be related to the available pore volume in the porous particles by the requirement that the mass ratio of silicon to the porous particles is in the range from [0.5×P¹ to 1.9×P¹]:1, wherein P¹ is a dimensionless quantity having the magnitude of the total pore volume of micropores and mesopores in the porous particles, as expressed in cm³/g (e.g. if the porous particles have a total volume of micropores and mesopores of 1.2 cm³/g, then P¹=1.2). This relationship takes into account the density of silicon and the pore volume of the porous particles to define a weight ratio of silicon at which the pore volume is around 20% to 82% occupied. Preferably, the weight ratio of silicon deposited in step (b) to the porous particles is in the range from [0.6×P¹ to 1.8×P¹]:1 or from [0.7×P¹ to 1.7×P¹]:1, or from [0.8×P¹ to 1.6×P¹]:1.

Preferably at least 90 wt %, more preferably at least 95 wt %, even more preferably at least 98 wt % of the electroactive material in the composite particles is located within the internal pore volume of the porous particle framework.

Preferably, the electroactive material is silicon and at least 22 wt %, or at least 25 wt %, at least 30 wt % of the silicon, or at least 35 wt % of the silicon, or at least 40 wt % of the silicon, or at least 45 wt % of the silicon is surface silicon as determined by TGA according to the method described above.

Preferably, the electroactive material is silicon and no more than 10 wt %, or no more than 8 wt %, or no more than 6 wt %, or no more than 5 wt %, or no more than 4 wt %, or no more than 3 wt %, or no more than 2 wt %, or no more than 1.5 wt % of the silicon is coarse bulk silicon as determined by TGA according to the method described above.

Preferably, at least 30 wt % of the silicon is surface silicon and no more than 10 wt % of the silicon is coarse bulk silicon, wherein both are determined by TGA. More preferably, at least 35 wt % of the silicon is surface silicon and no more than 8 wt % of the silicon is coarse bulk silicon, wherein both are determined by TGA. More preferably, at least 40 wt % of the silicon is surface silicon and no more than 5 wt % of the silicon is coarse bulk silicon, wherein both are determined by TGA. More preferably, at least 45 wt % of the silicon is surface silicon and no more than 2 wt % of the silicon is coarse bulk silicon, wherein both are determined by TGA.

The composite particles preferably have a BET surface area of no more than 100 m²/g, or no more than 80 m²/g, or no more than 60 m²/g, or no more than 50 m²/g, or no more than 40 m²/g, or no more than 30 m²/g, or no more than 25 m²/g, or no more than 20 m²/g, or no more than 15 m²/g, or no more than 10 m²/g, or no more than 5 m²/g. In general, a low BET surface area is preferred in order to minimize the formation of solid electrolyte interphase (SEI) layers at the surface of the composite particles during the first charge-discharge cycle of an anode. However, a BET surface area which is excessively low results in unacceptably low charging rate and capacity due to the inaccessibility of the bulk of the electroactive material to metal ions in the surrounding electrolyte. The BET surface area is preferably at least 0.1 m²/g, or at least 1 m²/g, or at least 2 m²/g, or at least 5 m²/g. For instance, the BET surface area of the composite particles may be in the range from 0.1 to 100 m²/g, or from 0.1 to 80 m²/g, or from 0.5 to 60 m²/g, or from 0.5 to 40 m²/g, or from 1 to 30 m²/g, or from 1 to 25 m²/g, or from 2 to 20 m²/g.

The composite particles preferably have a total pore volume of gas-accessible micropores and mesopores of no more than 0.1 cm³/g, or no more than 0.05 cm³/g, or no more than 0.02 cm³/g, or no more than 0.01 cm³/g, or no more than 0.008 cm³/g.

The composite particles of the invention may comprise a passivation layer on the surfaces of the nanoscale electroactive material domains and/or a lithium permeable material (preferably a pyrolytic carbon material) deposited into the pores and or the outer surfaces of the particles. Suitable methods for forming passivation layers and depositing lithium permeable materials are described above.

Preferably, the composite particles are non-agglomerated and non-aggregated particles. As used herein, the term “aggregated” refers to particles that grow together in the course of their manufacture and/or which are linked together via covalent bonds. Agglomerates refer to a cluster of primary particles or aggregates that are loosely bound together, for example, via Van der Waals interactions or hydrogen bonds. Agglomerates can easily be broken down into aggregates or primary particles via conventional kneading and dispersing processes. However, aggregates are bound via more durable bonding interactions and cannot be broken down easily into primary particles. The presence of the porous particles in the form of aggregates, agglomerates or isolated particles can be visualized, for example, by means of conventional scanning electron microscopy (SEM).

The composite particles preferably have a flowability (ff_{c},) of at least 4, preferably at least 4.5, preferably at least 5, preferably at least 6, more preferably at least 7, wherein ff_{c} is defined as σ₁/σ_{c}, where σ₁ is the consolidation stress and σ_{c} is the unconfined yield strength, as measured using a Schulze ring shear tester, for example a Brookfield™ powder flow tester, according to ASTM-D6773-16, and wherein the flowability is measured at σ₁=5 kPa.

The flowability of the composite particles is an important factor in the manufacture of electrode coatings, since excessively cohesive electrode materials have a significant impact on the ease of making high quality, homogenous electrode coatings from a slurry onto a current collector. If the powder is cohesive and does not flow easily then inhomogenous and poor coatings can ensue. The composite particles of the invention provide a powder with greater flowability than comparative materials.

The composite particles preferably have a tap density of more than 0.7 g/cm³, or at least 0.8 g/cm³, or at least 0.85 g/cm³, or at least 0.9 g/cm³, as measured in accordance with ISO 3953 and ISO 787(Determination of tamped volume and apparent density after tamping), using a Quantachrome™ Autotap. Drop height of the instrument is 3 mm and tapping frequency of the instrument is fixed at 250-265 taps/min. The sample is tapped at least 5,000 times. If the sample volume is still observed to be changing after 5,000 taps then additional increments of 1,250 taps are applied until no further volume change is observed.

Preferably in the composite particles of the invention:
(i) the porous particle framework has a total pore volume of micropores and mesopores as measured by nitrogen gas adsorption in the range from 0.4 to 1.8 cm³/g; a PD₅₀ pore diameter of no more than 10 nm; and preferably a PD₉₀ pore diameter of no more than 20 nm;
(ii) the electroactive material is silicon;
(iii) Z is no more than 10% and preferably Y is at least 30%;
(iv) the D₅₀ particle diameter is in the range from 1 to 20 μm;
(v) the D₁ particle diameter is at least 1.0 μm;
(vi) the ratio D₅₀/D₁ is no more than 5; and
(vii) the BET surface area is no more than 25 m²/g.

More preferably in the composite particles of the invention:
(i) the porous particle framework has a total pore volume of micropores and mesopores as measured by nitrogen gas adsorption in the range from 0.5 to 1.6 cm³/g; a PD₅₀ pore diameter of no more than 8 nm; and preferably a PD₉₀ pore diameter of no more than 15 nm;
(ii) the electroactive material is silicon;
(iii) Z is no more than 10% and preferably Y is at least 30%;
(iv) the D₅₀ particle diameter is in the range from 2 to 12 μm;
(v) the D₁ particle diameter is at least 1.0 μm;
(vi) the ratio D₅₀/D₁ is no more than 4; and
(vii) the BET surface area is no more than 25 m²/g.

More preferably in the composite particles of the invention:
(i) the porous particle framework has a total pore volume of micropores and mesopores as measured by nitrogen gas adsorption in the range from 0.6 to 1.5 cm³/g; a PD₅₀ pore diameter of no more than 6 nm; and preferably a PD₉₀ pore diameter of no more than 12 nm;
(ii) the electroactive material is silicon;
(iii) Z is no more than 8% and preferably Y is at least 35%;
(iv) the D₅₀ particle diameter is in the range from 2 to 12 μm;
(v) the D₁ particle diameter is at least 1.0 μm;
(vi) the ratio D₅₀/D₁ is no more than 3; and
(vii) the BET surface area is no more than 20 m²/g.

More preferably in the composite particles of the invention:
(i) the porous particle framework has a total pore volume of micropores and mesopores as measured by nitrogen gas adsorption in the range from 0.65 to 1.4 cm³/g; a PD₅₀ pore diameter of no more than 2.5 nm; and preferably a PD₉₀ pore diameter of no more than 10 nm;
(ii) the electroactive material is silicon;
(iii) Z is no more than 8% and preferably Y is at least 35%;
(iv) the D₅₀ particle diameter is in the range from 2 to 10 μm;
(v) the D₁ particle diameter is at least 1.0 μm;
(vi) the ratio D₅₀/D₁ is no more than 3; and
(vii) the BET surface area is no more than 20 m²/g.

Preferably in the composite particles of the invention:
(i) the porous particle framework has a total pore volume of micropores and mesopores as measured by nitrogen gas adsorption in the range from 0.4 to 1.8 cm³/g; a PD₅₀ pore diameter of no more than 10 nm; and preferably a PD₉₀ pore diameter of no more than 20 nm;
(ii) the electroactive material is silicon;
(iii) Z is no more than 10% and preferably Y is at least 30%;
(iv) the D₅₀ particle diameter is in the range from 1 to 20 μm;
(v) the D₁ particle diameter is at least 1.0 μm;
(vi) the ratio D₉₈/D₁ is no more than 10; and
(vii) the BET surface area is no more than 25 m²/g.

More preferably in the composite particles of the invention:
(i) the porous particle framework has a total pore volume of micropores and mesopores as measured by nitrogen gas adsorption in the range from 0.5 to 1.6 cm³/g; a PD₅₀ pore diameter of no more than 8 nm; and preferably a PD₉₀ pore diameter of no more than 15 nm;
(ii) the electroactive material is silicon;
(iii) Z is no more than 10% and preferably Y is at least 30%;
(iv) the D₅₀ particle diameter is in the range from 2 to 12 μm;
(v) the D₁ particle diameter is at least 1.0 μm;
(vi) the ratio D₉₈/D₁ is no more than 8; and
(vii) the BET surface area is no more than 25 m²/g.

More preferably in the composite particles of the invention:
(i) the porous particle framework has a total pore volume of micropores and mesopores as measured by nitrogen gas adsorption in the range from 0.6 to 1.5 cm³/g; a PD₅₀ pore diameter of no more than 6 nm; and preferably a PD₉₀ pore diameter of no more than 12 nm;
(ii) the electroactive material is silicon;
(iii) Z is no more than 8% and preferably Y is at least 35%;
(iv) the D₅₀ particle diameter is in the range from 2 to 12 μm;
(v) the D₁ particle diameter is at least 1.0 μm;
(vi) the ratio D₉₈/D₁ is no more than 6; and
(vii) the BET surface area is no more than 20 m²/g.

Preferably in the composite particles of the invention:
(i) the porous particle framework has a total pore volume of micropores and mesopores as measured by nitrogen gas adsorption in the range from 0.4 to 1.8 cm³/g; a PD₅₀ pore diameter of no more than 10 nm; and preferably a PD₉₀ pore diameter of no more than 20 nm;
(ii) the electroactive material is silicon;
(iii) Z is no more than 10% and preferably Y is at least 30%;
(iv) the D₅₀ particle diameter is in the range from 1 to 20 μm;
(v) the D₁ particle diameter is at least 1.0 μm;
(vi) preferably the D₉₈ particle diameter is no more than 16 μm;
(vii) D₉₈-D₁ is no more than 15 μm; and
(viii) the BET surface area is no more than 25 m²/g.

More preferably in the composite particles of the invention:
(i) the porous particle framework has a total pore volume of micropores and mesopores as measured by nitrogen gas adsorption in the range from 0.5 to 1.6 cm³/g; a PD₅₀ pore diameter of no more than 8 nm; and preferably a PD₉₀ pore diameter of no more than 15 nm;
(ii) the electroactive material is silicon;
(iii) Z is no more than 10% and preferably Y is at least 30%;
(iv) the D₅₀ particle diameter is in the range from 2 to 12 μm;
(v) the D₁ particle diameter is at least 1.0 μm;
(vi) preferably the D₉₈ particle diameter is no more than 16 μm;
(vii) D₉₈−D₁ is no more than 13 μm; and
(viii) the BET surface area is no more than 25 m²/g.

More preferably in the composite particles of the invention:
(i) the porous particle framework has a total pore volume of micropores and mesopores as measured by nitrogen gas adsorption in the range from 0.6 to 1.5 cm³/g; a PD₅₀ pore diameter of no more than 6 nm; and preferably a PD₉₀ pore diameter of no more than 12 nm;
(ii) the electroactive material is silicon;
(iii) Z is no more than 8% and preferably Y is at least 35%;
(iv) the D₅₀ particle diameter is in the range from 2 to 12 μm;
(v) the D₁ particle diameter is at least 1.0 μm;
(vi) preferably the D₉₈ particle diameter is no more than 16 μm;
(vii) D₉₈-D₁ is no more than 12 μm; and
(viii) the BET surface area is no more than 20 m²/g.

More preferably in the composite particles of the invention:
(i) the porous particle framework has a total pore volume of micropores and mesopores as measured by nitrogen gas adsorption in the range from 0.7 to 1.3 cm³/g; a PD₅₀ pore diameter of no more than 4 nm; and preferably a PD₉₀ pore diameter of no more than 8 nm;
(ii) the electroactive material is silicon;
(iii) Z is no more than 5% and preferably Y is at least 40%;
(iv) the D₅₀ particle diameter is in the range from 2 to 10 μm;
(v) the D₁ particle diameter is at least 1.5 μm;
(vi) the ratio D₅₀/D₁ is preferably no more than 5; and
(vii) the BET surface area is no more than 15 m²/g.

More preferably in the composite particles of the invention:
(i) the porous particle framework has a total pore volume of micropores and mesopores as measured by nitrogen gas adsorption in the range from 0.75 to 1.2 cm³/g; a PD₅₀ pore diameter of no more than 3 nm; and preferably a PD₉₀ pore diameter of no more than 6 nm;
(ii) the electroactive material is silicon;
(iii) Z is no more than 5% and preferably Y is at least 40%;
(iv) the D₅₀ particle diameter is in the range from 2 to 10 μm;
(v) the D₁ particle diameter is at least 1.8 μm;
(vi) the ratio D₅₀/D₁ is preferably no more than 4; and
(vii) the BET surface area is no more than 15 m²/g.

More preferably in the composite particles of the invention:
(i) the porous particle framework has a total pore volume of micropores and mesopores as measured by nitrogen gas adsorption in the range from 0.8 to 1.2 cm³/g; a PD₅₀ pore diameter of no more than 2 nm, and preferably a PD₉₀ pore diameter of no more than 5 nm;
(ii) the electroactive material is silicon;
(iii) Z is no more than 2% and preferably Y is at least 45%;
(iv) the D₅₀ particle diameter is in the range from 2.5 to 8 μm; and
(v) the D₁ particle diameter is at least 2 μm;
(vi) the ratio D₅₀/D₁ is preferably no more than 3; and
(vii) the BET surface area is no more than 10 m²/g.

More preferably in the composite particles of the invention:
(i) the porous particle framework has a total pore volume of micropores and mesopores as measured by nitrogen gas adsorption in the range from 0.7 to 1.3 cm³/g; a PD₅₀ pore diameter of no more than 4 nm; and preferably a PD₉₀ pore diameter of no more than 8 nm;
(ii) the electroactive material is silicon;
(iii) Z is no more than 5% and preferably Y is at least 40%;
(iv) the D₅₀ particle diameter is in the range from 2 to 10 μm;
(v) the D₁ particle diameter is at least 1.5 μm;
(vi) the ratio D₉₈/D₁ is preferably no more than 10; and
(vii) the BET surface area is no more than 15 m²/g.

More preferably in the composite particles of the invention:
(i) the porous particle framework has a total pore volume of micropores and mesopores as measured by nitrogen gas adsorption in the range from 0.75 to 1.2 cm³/g; a PD₅₀ pore diameter of no more than 3 nm; and preferably a PD₉₀ pore diameter of no more than 6 nm;
(ii) the electroactive material is silicon;
(iii) Z is no more than 5% and preferably Y is at least 40%;
(iv) the D₅₀ particle diameter is in the range from 2 to 10 μm;
(v) the D₁ particle diameter is at least 1.8 μm;
(vi) the ratio D₉₈/D₁ is preferably no more than 8; and
(vii) the BET surface area is no more than 15 m²/g.

More preferably in the composite particles of the invention:
(i) the porous particle framework has a total pore volume of micropores and mesopores as measured by nitrogen gas adsorption in the range from 0.8 to 1.2 cm³/g; a PD₅₀ pore diameter of no more than 2 nm, and preferably a PD₉₀ pore diameter of no more than 5 nm;
(ii) the electroactive material is silicon;
(iii) Z is no more than 2% and preferably Y is at least 45%;
(iv) the D₅₀ particle diameter is in the range from 2.5 to 8 μm; and
(v) the D₁ particle diameter is at least 2 μm;
(vi) the ratio D₉₈/D₁ is preferably no more than 6; and
(vii) the BET surface area is no more than 10 m²/g.

More preferably in the composite particles of the invention:
(i) the porous particle framework has a total pore volume of micropores and mesopores as measured by nitrogen gas adsorption in the range from 0.7 to 1.3 cm³/g; a PD₅₀ pore diameter of no more than 4 nm; and preferably a PD₉₀ pore diameter of no more than 8 nm;
(ii) the electroactive material is silicon;
(iii) Z is no more than 5% and preferably Y is at least 40%;
(iv) the D₅₀ particle diameter is in the range from 2 to 10 μm;
(v) the D₁ particle diameter is at least 1.5 μm;
(vi) preferably the D₉₈ particle diameter is no more than 16 μm;
(vii) the value of (D₉₈−D₁)/D₅₀ is no more than 2; and
(viii) the BET surface area is no more than 15 m²/g.

More preferably in the composite particles of the invention:
(i) the porous particle framework has a total pore volume of micropores and mesopores as measured by nitrogen gas adsorption in the range from 0.75 to 1.2 cm³/g; a PD₅₀ pore diameter of no more than 3 nm; and preferably a PD₉₀ pore diameter of no more than 6 nm;
(ii) the electroactive material is silicon;
(iii) Z is no more than 5% and preferably Y is at least 40%;
(iv) the D₅₀ particle diameter is in the range from 2 to 10 μm;
(v) the D₁ particle diameter is at least 1.8 μm;
(vi) preferably the D₉₈ particle diameter is no more than 16 μm;
(vii) the value of (D₉₈−D₁)/D₅₀ is no more than 1.8; and
(viii) the BET surface area is no more than 15 m²/g.

More preferably in the composite particles of the invention:
(i) the porous particle framework has a total pore volume of micropores and mesopores as measured by nitrogen gas adsorption in the range from 0.8 to 1.2 cm³/g; a PD₅₀ pore diameter of no more than 2 nm, and preferably a PD₉₀ pore diameter of no more than 5 nm;
(ii) the electroactive material is silicon;
(iii) Z is no more than 2% and preferably Y is at least 45%;
(iv) the D₅₀ particle diameter is in the range from 2.5 to 8 μm; and
(v) the D₁ particle diameter is at least 2 μm;
(vi) preferably the D₉₈ particle diameter is no more than 16 μm;
(vii) the value of (D₉₈−D₁)/D₅₀ is no more than 1.8; and
(viii) the BET surface area is no more than 10 m²/g.

The composite particles of the second aspect of the invention may be obtained by the process of the first aspect of the invention. Alternatively, the composite particles of the second aspect of the invention may be obtained by providing a population of composite particles according to any of the prior disclosures of the applicant (see, for example, WO 2022/029422) and classifying the population of composite particles to obtain a population of particles having a D₁ particle diameter of at least 0.5 μm and a D₅₀ particle diameter in the range from 1 to 20 μm.

In a third aspect of the invention, there is provided a composition comprising composite particles according to the second aspect of the invention and at least one other component. In particular, there is provided a composition comprising composite particles according to the second aspect of the invention and at least one other component selected from: (i) a binder; (ii) a conductive additive; and (iii) an additional particulate electroactive material. The composition according to the third aspect of the invention is useful as an electrode composition, and thus may be used to form the active layer of an electrode.

The composition may be a hybrid electrode composition which comprises the composite particles and at least one additional particulate electroactive material. Without being bound by theory, it is believed that the carefully controlled particle size distribution of the composite particles of the invention is advantageous for use in hybrid electrode compositions since it provides improved compatibility with the at least one additional particulate electroactive material.

Examples of additional particulate electroactive materials include graphite, hard carbon, silicon, tin, germanium, aluminium and lead. The at least one additional particulate electroactive material is preferably selected from graphite and hard carbon, and most preferably the at least one additional particulate electroactive material is graphite.

In the case of a hybrid electrode composition, the composition may comprise at least 5 wt %, or at least 8 wt %, or at least 10 wt %, or at least 12 wt %, or at least 15 wt % of the composite particles according to the second aspect of the invention, based on the total dry weight of the composition. Optionally, the hybrid electrode composition may comprise up to 60 wt % or up to 50 wt % or up to 40 wt % or up to 30 wt % or up to 25 wt % of the composite particles according to the second aspect of the invention, based on the total dry weight of the composition.

Preferably, a hybrid electrode composition comprises from 3 to 60 wt %, or from 3 to 50 wt %, or from 5 to 40 wt %, or from 10 to 30 wt %, or from 15 to 25 wt %, of the composite particles according to the second aspect of the invention, based on the total dry weight of the composition.

The at least one additional particulate electroactive material is suitably present in an amount of from 20 to 95 wt %, or from 25 to 90 wt %, or from 30 to 75 wt % of the at least one additional particulate electroactive material.

The at least one additional particulate electroactive material preferably has a D₅₀ particle diameter in the range from 10 to 50 μm, preferably from 10 to 40 μm, more preferably from 10 to 30 μm and most preferably from 10 to 25 μm, for example from 15 to 25 μm.

The D₁₀ particle diameter of the at least one additional particulate electroactive material is preferably at least 5 μm, more preferably at least 6 μm, more preferably at least 7 μm, more preferably at least 8 μm, more preferably at least 9 μm, and still more preferably at least 10 μm.

The D₉₀ particle diameter of the at least one additional particulate electroactive material is preferably up to 100 μm, more preferably up to 80 μm, more preferably up to 60 μm, more preferably up to 50 μm, and most preferably up to 40 μm.

The at least one additional particulate electroactive material is preferably selected from carbon-comprising particles, graphite particles and/or hard carbon particles, wherein the graphite and hard carbon particles have a D₅₀ particle diameter in the range from 10 to 50 μm. Still more preferably, the at least one additional particulate electroactive material is selected from graphite particles, wherein the graphite particles have a D₅₀ particle diameter in the range from 10 to 50 μm.

The composition may also be a non-hybrid (or “high loading”) electrode composition which is substantially free of additional particulate electroactive materials. In this context, the term “substantially free of additional particulate electroactive materials” should be interpreted as meaning that the composition comprises less than 15 wt %, preferably less than 10 wt %, preferably less than 5 wt %, preferably less than 2 wt %, more preferably less than 1 wt %, more preferably less than 0.5 wt % of any additional electroactive materials (i.e. additional materials which are capable of inserting and releasing metal ions during the charging and discharging of a battery), based on the total dry weight of the composition.

A “high-loading” electrode composition of this type preferably comprises at least 50 wt %, or at least 60 wt %, or at least 70 wt %, or at least 80 wt %, or at least 90 wt % of the composite particles of the second aspect of the invention, based on the total dry weight of the composition.

The composition may optionally comprise a binder. A binder functions to adhere the composition to a current collector and to maintain the integrity of the composition.

Examples of binders which may be used in accordance with the present invention include polyvinylidene fluoride (PVDF), polyacrylic acid (PAA) and alkali metal salts thereof, modified polyacrylic acid (mPAA) and alkali metal salts thereof, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR) and polyimide. The composition may comprise a mixture of binders. Preferably, the binder comprises polymers selected from polyacrylic acid (PAA) and alkali metal salts thereof, and modified polyacrylic acid (mPAA) and alkali metal salts thereof, SBR and CMC.

The binder may suitably be present in an amount of from 0.5 to 20 wt %, preferably 1 to 15 wt %, preferably 2 to 10 wt % and most preferably 5 to 10 wt %, based on the total dry weight of the composition.

The binder may optionally be present in combination with one or more additives that modify the properties of the binder, such as cross-linking accelerators, coupling agents and/or adhesive accelerators.

The composition may optionally comprise one or more conductive additives. Preferred conductive additives are non-electroactive materials that are included so as to improve electrical conductivity between the electroactive components of the composition and between the electroactive components of the composition and a current collector. The conductive additives may be selected from carbon black, carbon fibers, carbon nanotubes, graphene, acetylene black, ketjen black, metal fibers, metal powders and conductive metal oxides. Preferred conductive additives include carbon black and carbon nanotubes.

The one or more conductive additives may suitably be present in a total amount of from 0.5 to 20 wt %, preferably 1 to 15 wt %, preferably 2 to 10 wt % and most preferably 5 to 10 wt %, based on the total dry weight of the composition.

In a fourth aspect, the invention provides an electrode comprising composite particles according to the second aspect of the invention in electrical contact with a current collector. The particulate material used to prepare the electrode of the fourth aspect of the invention may be in the form of a composition according to the third aspect of the invention.

As used herein, the term current collector refers to any conductive substrate that is capable of carrying a current to and from the electroactive particles in the composition. Examples of materials that can be used as the current collector include copper, aluminium, stainless steel, nickel, titanium and sintered carbon. Copper is a preferred material. The current collector is typically in the form of a foil or mesh having a thickness of between 3 to 500 μm. The particulate materials of the invention may be applied to one or both surfaces of the current collector to a thickness which is preferably in the range from 10 μm to 1 mm, for example from 20 to 500 μm, or from 50 to 200 μm.

The electrode of the fourth aspect of the invention may be fabricated by combining the particulate material of the invention with a solvent and optionally one or more viscosity modifying additives to form a slurry. The slurry is then cast onto the surface of a current collector and the solvent is removed, thereby forming an electrode layer on the surface of the current collector. Further steps, such as heat treatment to cure any binders and/or calendaring of the electrode layer may be carried out as appropriate. The electrode layer suitably has a thickness in the range from 20 μm to 2 mm, preferably 20 μm to 1 mm, preferably 20 μm to 500 μm, preferably 20 μm to 200 μm, preferably 20 μm to 100 μm, preferably 20 μm to 50 μm.

Alternatively, the slurry may be formed into a freestanding film or mat comprising the particulate material of the invention, for instance by casting the slurry onto a suitable casting template, removing the solvent and then removing the casting template. The resulting film or mat is in the form of a cohesive, freestanding mass that may then be bonded to a current collector by known methods.

The electrode of the fourth aspect of the invention may be used as the anode of a metal-ion battery. Thus, in a fifth aspect, the present invention provides a rechargeable metal-ion battery comprising the electrode of the fourth aspect as the anode.

The metal ions are preferably lithium ions. More preferably, the rechargeable metal-ion battery of the invention is a lithium-ion battery, and the cathode active material is capable of releasing and accepting lithium ions.

The cathode of the rechargeable metal-ion battery typically comprises a current collector and a cathode active material capable of releasing and reabsorbing metal ions.

The cathode active material is preferably a metal oxide-based composite. Examples of suitable cathode active materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

A suitable electrolyte is a non-aqueous electrolyte containing a metal salt, e.g. a lithium salt, and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylene carbonates, dimethyl carbonate, diethyl carbonate, gamma butyrolactone, 1,2-dimethoxyethane, 2-methyltetrahydrofuran, dimethylsulfoxide, 1,3-dioxolane, formamide, dimethylformamide, acetonitrile, nitromethane, methylformate, methyl acetate, phosphoric acid triesters, trimethoxymethane, sulfolane, methyl sulfolane and 1,3-dimethyl-2-imidazolidinone.

Examples of organic solid electrolytes include polyethylene derivatives polyethyleneoxide derivatives, polypropylene oxide derivatives, phosphoric acid ester polymers, polyester sulfide, polyvinylalcohols, polyvinylidine fluoride and polymers containing ionic dissociation groups.

Examples of inorganic solid electrolytes include nitrides, halides and sulfides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the metal-ion battery is preferably provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

The separator may be replaced by a polymer electrolyte material and in such cases the polymer electrolyte material may be present within both the composite anode layer and the composite cathode layer. The polymer electrolyte material can be a solid polymer electrolyte or a gel-type polymer electrolyte.

### Example 1: General Procedure for Silicon Deposition

A 5.0 L stirred pressure reactor was filled with 300 g of porous carbon particles. The reactor was sealed and slowly placed under vacuum (10 mbar) to remove the air and then filled with dry nitrogen or argon that was free of oxygen. The process was repeated three times to expel all of the air from the porous carbon particles. The reactor heated to 340° C., evacuated again, and filled with silane to a pressure of 1.2 MPa. The reactor was then heated to 400° C. at a ramp rate of 10° C./min and held at 400° C. for 30 mins. The reactor was then cooled to 340° C. and slowly depressurised. The reactor was then refilled with silane to 1.2 MPa and heated again to 400° C. at 10° C./min and held there for a further 30 mins. The cooling and refilling steps were repeated for a total of 6 cycles. The reactor was depressurised and filled with nitrogen or argon then cooled to below 30° C. The composite particle product was then passivated with air by using a mixture of 10% air in nitrogen by evacuating the reactor and filling it with the gas to a pressure of 0.1 MPa and allowing it to stand for 15 minutes. This process was repeated 3 times using the mixture of 10% air in nitrogen, 3 times using 25% air in nitrogen, once with 50% air in nitrogen, once with 75% air in nitrogen, and finally with 100% air.

### Example 2

Porous particle frameworks having the properties set out in Table 1, were infiltrated according to the procedure of Example 1. Sample A is an unclassified porous particle framework with a skew of 2.9. Sample B is a porous particle framework with a skew of 1.3, that is obtained by air classification of Sample A to remove fines.

TABLE 1

| | | | D₁₀; | | | |
|---|---|---|---|---|---|---|
| Sample | D₁/μm | D₅₀/μm | D₉₀/μm | PV/g · cm⁻³ | MPF | BET/m²g⁻¹ |
| A | 0.53 | 5.42 | 1.75; | 0.7 | 0.73 | 1683 |
| | | | 10.4 | | | |
| B | 3.18 | 7.37 | 4.44; | 0.7 | 0.70 | 1681 |
| | | | 12.1 | | | |

* PV denotes the total volume of micropores and mesopores as measured by nitrogen gas adsorption; MPF denotes the micropore volume fraction, based on the total volume of micropores and mesopores in the porous particles; BET denotes the BET surface area of the porous particles.

Properties of the silicon-carbon composite particles are provided in Table 2. Sample C with a skew of 1.9 is obtained by infiltration of Sample A (i.e. without classification). Sample D with a skew of 1.0 is obtained according to the process of the invention.

TABLE 2

| | | | D₁₀; | Tap density | | Coarse | Surface | |
|---|---|---|---|---|---|---|---|---|
| Sample | D₁/μm | D₅₀/μm | D₉₀/μm | g/cm³ | Si/% | Si/% | Si/% | BET/m²g⁻¹ |
| C | 0.85 | 5.44 | 2.26; | 0.7 | 51.1 | 6.2 | 34.2 | 19 |
| | | | 10.4 | | | | | |
| D | 3.40 | 7.73 | 4.75; | 0.85 | 50.1 | 2.7 | 43.8 | 7 |
| | | | 12.1 | | | | | |

*Si denotes the silicon content as a percentage by mass of the composite particles; Coarse Si denotes the content of “coarse bulk silicon” as determined by TGA according to the method defined herein; Surface Si denotes “surface silicon” as determined by TGA according to the method defined herein.

The results in Table 2 demonstrate a marked reduction in the formation of coarse bulk silicon and an increase in the formation of surface silicon when composite particles are prepared according to the process of the invention. This demonstrates that fine particles make a significant contribution to the formation of coarse silicon structures. As set out above, it is known that the presence of coarse bulk silicon results in inferior capacity retention when the composite particles are used in lithium-ion batteries.

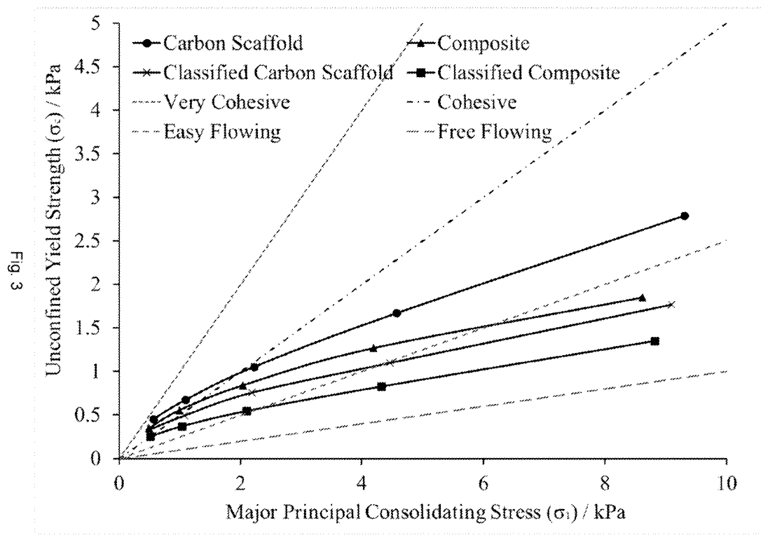

Samples A to D were also tested for their cohesiveness with the results shown in FIG. 3. It is found that a marked reduction in cohesiveness (an increase in the instantaneous flowability function) is observed both for the classified porous particles and the classified composite particles. This demonstrates the advantages of the invention both for the processing of the porous particles during production of the composite particles and for the processing of the composite particles during production of electrode.

### Example 3

Porous particle frameworks having the properties set out in Table 3 (Sample E), were infiltrated according to the procedure of Example 1. The product was analysed before and after air classification to remove fine particles. Properties of the silicon-carbon composite particles are provided in Table 4. Sample F, with a skew of 2.8, is obtained by infiltration of Sample E without classification. Sample G, with a skew of 1.3, is obtained following air classification of Sample F.

TABLE 3

| | | | D₁₀; | | | |
|---|---|---|---|---|---|---|
| Sample | D₁/μm | D₅₀/μm | D₉₀/μm | PV/g · cm⁻³ | MPF | BET/m²g⁻¹ |
| E | 0.49 | 3.29 | 1.19; | 0.74 | 0.61 | 1623 |
| | | | 7.54 | | | |

TABLE 4

| | | | D₁₀; | Tap density | | Coarse | Surface | |
|---|---|---|---|---|---|---|---|---|
| Sample | D₁/μm | D₅₀/μm | D₉₀/μm | g/cm³ | Si/% | Si/% | Si/% | BET/m²g⁻¹ |
| F | 0.64 | 3.26 | 1.23; 7.73 | 0.57 | 52 | 2.1 | 51.4 | 29 |
| G | 3.05 | 7.15 | 4.26; 11.9 | 0.84 | 51.5 | 0.6 | 54.5 | 20 |

The results in Table 4 demonstrate that coarse bulk silicon is formed primarily on the fine fraction of the porous particles. Classification of the composite particle product therefore provides a product having a reduced coarse bulk silicon content and an increased surface silicon content, which would therefore be expected to have improved reversible capacity retention in a lithium-ion battery.

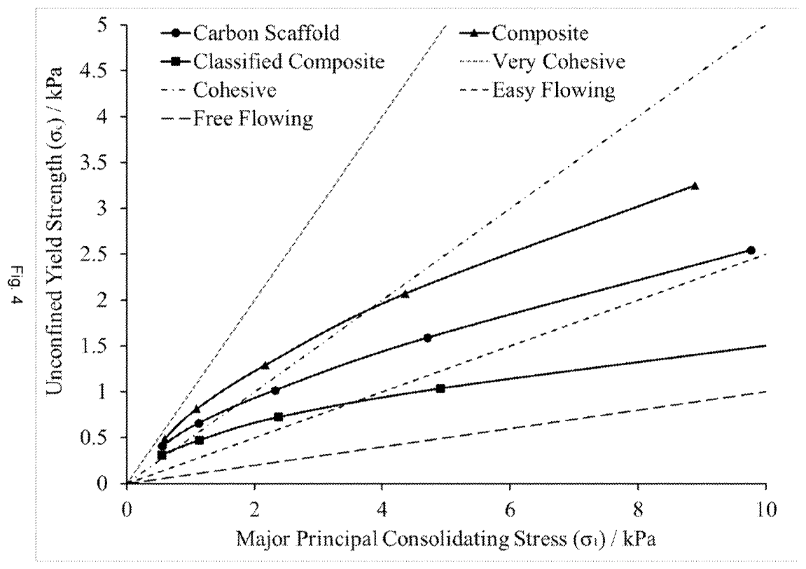

Samples E to G were also tested for their cohesiveness (flowability) with the results shown in FIG. 4. Once again, a marked reduction in cohesiveness is observed for the classified composite particles.

### Example 4

Negative electrodes (anodes) were prepared using the Si-C composite particles of samples D, F (comparative) and G and tested for reversible capacity retention in single layer pouch cells.

To make the electrodes, a dispersion of carbon black in PAA binder was mixed in a Thinky™ mixer. Electrochemically active graphites were added to the dispersion and mixed for 15-minutes. The Si-C composite particle samples were then added and mixed for 15 minutes. The ratio of the active material in the electrode is as follows: Graphite:Si-C composite 74 wt %:15 wt %. The remaining 11 wt % was constituted by 4 wt % of the carbon black (conductive additive) and 7 wt % of the PAA binder. The slurry was coated onto a 10 μm thick copper substrate (current collector) and dried at 50° C. for 10 minutes, then at 80° C. for 10 minutes followed by calendering. An additional drying step was carried out at 110° C. for 12 hours to form a negative electrode with a coating density of 1.5 g/cm3±0.5 g/cm³.

Full pouch cells were made using this electrode as the negative electrode with a porous polyethylene separator and a nickel manganese cobalt (NMC532) positive electrode.

The positive and negative electrodes were designed to form a balanced pair, such that the capacity ratio of the positive to negative electrodes was 0.9. An electrolyte comprising 1M LiPF₆ in a solution of fluoroethylene carbonate, ethylene carbonate and ethyl methyl carbonate containing 3 wt % vinylene carbonate was then added to the cell before sealing.

The single layer pouch cells were cycled as follows: A constant current was applied at a rate of C/10, to lithiate the anode, with a cut off voltage of 4.2 V. When the cut off voltage was reached, a constant voltage of 4.2 V is applied until a cut off current of C/40 is reached. The cell was then rested for 2 minutes in the lithiated state. The anode was then delithiated at a constant current of C/10 with a cut off voltage of 3.0 V. The cell was then rested for 2 minutes. This charge-discharge cycle was then repeated for 500 cycles. The capacity retention at 100 cycles (CR100), 500 cycles (CR500), 680 cycles (CR680) and 1000 cycles (CR1000) was calculated and is given in Table 5.

TABLE 5

| Sample | CR100 | CR500 | CR680 | CR1000 |
|---|---|---|---|---|
| D | 93.7 | 86.5 | 84.6 | 81.3 |
| F* | 92.7 | 80.1 | 76.3 | |
| G | 94.4 | 86.5 | 83.7 | 78.8 |

*Comparative sample

It can be seen from Table 5 that Sample D (manufactured by CVI into air classified porous particle frameworks) and Sample G (classified composite particle product) have significantly improved cycling performance compared to comparative Sample F. For example, the cell comprising sample D cycled twice as long as the cell comprising comparative sample F before its capacity reduced to 80% of the initial charge capacity (>1000 cycles for D vs ˜500 cycles for F). The cell comprising sample G reached 80% capacity retention at 920 cycles.

1. A process for preparing composite particles, the process comprising the steps of:
(a) providing a plurality of porous particles comprising micropores and mesopores
wherein the micropores and mesopores have a total pore volume as measured by nitrogen gas adsorption of 0.4 to 2.0 cm³/g, and
wherein the porous particles have a D₁ particle diameter of at least 0.5 μm, and a D₅₀ particle diameter in the range from 1 to 20 μm;
(b) contacting the porous particles with a precursor of an electroactive material at a temperature effective to cause deposition of a plurality of electroactive material domains in the pores of the porous particles.

2. A process according to claim 1, wherein the D₁ particle diameter of the porous particles is at least 0.8 μm, or at least 1.0 μm, or at least 1.2 μm, or at least 1.4 μm, or at least 1.5 μm, or at least 1.6 μm, or at least 1.8 μm, or at least 2.0 μm, or at least 2.2 μm, or at least 2.4 μm, or at least 2.5 μm, or at least 2.6 μm, or at least 2.8 μm, or at least 3.0 μm.

3. A process according to claim 1, wherein the D₅₀ particle diameter of the porous particles is in the range from 1.5 to 18 μm, or in the range from 1.5 to 15 μm, or in the range from 2 to 12 μm, or in the range from 2 to 10 μm, or in the range from 2.5 to 8 μm, or in the range from 3 to 8 μm.

4. A process according to claim 1, wherein the D₉₀ particle diameter of the porous particles is no more than 25 μm, or no more than 20 μm, or no more than 18 μm, or no more than 15 μm, or no more than 13 μm, or no more than 12 μm.

5. A process according to claim 1, wherein the D₁ particle diameter is in the range from 0.8 to 5.0 μm and the D₉₀ particle diameter is in the range from 6 to 15 μm, preferably wherein the D₁ particle diameter is in the range from 1.0 to 5.0 μm and the D₉₀ particle diameter is in the range from 7.5 to 15 μm, preferably wherein the D₁ particle diameter is in the range from 1.5. to 4.5 μm and the D₉₀ particle diameter is in the range from 9 to 15 μm, preferably wherein the D₁ particle diameter is in the range from 2 to 4 μm and the D₉₀ particle diameter is in the range from 10 to 14 μm, preferably wherein the D₁ particle diameter is in the range from 2.5 to 3.5 μm and the D₉₀ particle diameter is in the range from 11 to 13 μm.

6. A process according to claim 1, wherein the D₉₈ particle diameter of the porous particles is no more than 35 μm, or no more than 30 μm, or no more than 25 μm, or no more than 20 μm, or no more than 18 μm, or no more than 16 μm, or no more than 15 μm, or no more than 12 μm.

7. A process according to claim 1, wherein the D₁₀₀ particle diameter of the porous particles is no more than 40 μm, or no more than 35 μm, or no more than 30 μm, or no more than 25 μm, or no more than 20 μm, or no more than 16 μm.

8. A process according to claim 1, wherein the difference between the D₉₈ particle diameter and the D₁ particle diameter of the porous particles (D₉₈−D₁) is no more than 18 μm, or no more than 16 μm, or no more than 15 μm, or no more than 14 μm, or no more than 13 μm, or no more than 12 μm.

9. A process according to claim 1, wherein the ratio of the D₉₈ particle diameter to the D₁ particle diameter of the porous particles (D₉₈/D₁) is no more than 12, or no more than 10, or no more than 8, or no more than 6, or no more than 5.

10. A process according to claim 1, wherein (D₉₈−D₁)/D₅₀ is no more than 2.2, or no more than 2, or no more than 1.9, or no more than 1.8, or no more than 1.7, or no more than 1.6.

11. A process according to claim 1, wherein the difference between the D₉₀ particle diameter and the D₁ particle diameter of the porous particles (D₉₀−D₁) is no more than 12.0 μm, or no more than 10.0 μm, or no more than 9.0 μm, or no more than 8.0 μm.

12. A process according to claim 1, wherein the ratio of the D₉₀ particle diameter to the D₁ particle diameter of the porous particles (D₉₀/D₁) is no more than 12.0, or no more than 10.0, or no more than 9.0, or no more than 8.0, or no more than 7.0, or no more than 6.0, or no more than 5.0.

13. A process according to claim 1, wherein (D₉₀−D₁)/D₅₀ is no more than 2.2, or no more than 2, or no more than 1.9, or no more than 1.8, or no more than 1.7, or no more than 1.6.

14. A process according to claim 1 wherein the ratio of the D₅₀ particle diameter to the D₁ particle diameter of the porous particles (D₅₀/D₁) is no more than 10.0, or no more than 8.0, or no more than 7.0, or no more than 6.0, or no more than 5.0, or no more than 4.0, or no more than 3.0, or no more than 2.5.

15. A process according to claim 1, wherein the particle size distribution of the porous particles has a positive skew.

16. A process according to claim 1, wherein the total pore volume of micropores and mesopores in the porous particles as measured by gas adsorption is in the range from 0.4 to 1.8 cm³/g, or from 0.4 to 1.7 cm³/g, or from 0.5 to 1.6 cm³/g, or from 0.5 to 1.55 cm³/g, or from 0.6 to 1.5 cm³/g, or from 0.6 to 1.45 cm³/g, or from 0.65 to 1.4 cm³/g, or from 0.65 to 1.35 cm³/g, or from 0.7 to 1.3 cm³/g, or from 0.7 to 1.25 cm³/g, or from 0.75 to 1.2 cm³/g, or from 0.75 to 1.1 cm³/g, or from 0.8 to 1.15 cm³/g, or from 0.8 to 1.1 cm³/g.

17. A process according to claim 1, wherein the PD₅₀ pore diameter of the porous particles is no more than 10 nm, or no more than 8 nm, or no more than 6 nm, or no more than 5 nm, or no more than 4 nm, or no more than 3 nm, or no more than 2.5 nm, or no more than 2 nm, or no more than 1.9 nm, or no more than 1.8 nm, or no more than 1.7 nm, or no more than 1.6 nm.

18. A process according to claim 1, wherein the PD₉₀ pore diameter of the porous particles is in the range from 1.5 to 20 nm, or from 2 to 20 nm, or from 3.2 to 20 nm, or from 3.5 to 15 nm, or from 3.8 to 10 nm, or from 4 to 8 nm.

19. A process according to claim 1, wherein the micropore volume fraction is in the range from 0.35 to 0.98, or in the range from 0.4 to 0.95, or in the range from 0.4 to 0.90, or in the range from 0.4 to 0.85, or in the range from 0.45 to 0.85, or in the range from 0.5 to 0.8, or in the range from 0.55 to 0.8, or in the range from 0.6 to 0.8, or in the range from 0.61 to 0.79.

20. A process according to claim 1, wherein the porous particles have a BET surface area in the range from 500 m²/g to 4,000 m²/g, or from 750 m²/g to 3,500 m²/g, or from 1,000 m²/g to 3,250 m²/g, or from 1,000 m²/g to 3,000 m²/g, or from 1,000 m²/g to 2,500 m²/g, or from 1,000 m²/g to 2,000 m²/g.

21. A process according to claim 1, wherein step (a) comprises a step of classifying porous particles by size to provide a plurality of porous particles having the specified D₁ and D₅₀ values.

22. A process according to claim 21, wherein step (a) comprises:
(i) providing a precursor population of porous particles comprising micropores and mesopores, wherein the micropores and mesopores have a total pore volume as measured by nitrogen gas adsorption of 0.4 to 2.0 cm³/g, and
(ii) classifying the precursor population of particles to obtain the plurality of porous particles as defined herein for use in step (a).

23. A process according to claim 1, wherein the porous particles are conductive porous particles, preferably conductive porous carbon particles, more preferably conductive porous carbon particles comprising at least 80 wt % carbon, or at least 85 wt % carbon, or at least 90 wt % carbon, or at least 95 wt % carbon.

24. A process according to claim 1, wherein the precursor of the electroactive material is a gaseous precursor.

25. A process according to claim 24, wherein step (b) comprises contacting the porous particles with a gas comprising at least 30 vol %, or at least 40 vol %, or at least 50 vol %, or at least 60 vol %, or at least 70 vol %, or at least 80 vol %, or at least 90 vol %, or at least 95 vol %, or at least 97 vol %, or at least 99 vol % of the precursor of the electroactive material based on the total volume of the gas.

26. A process according to claim 1, wherein the electroactive material deposited in step (b) is selected from silicon, tin, germanium, aluminium and mixtures and alloys thereof, preferably wherein the electroactive material deposited in step (b) is silicon, preferably wherein the precursor of the electroactive material is selected from silane, disilane, trisilane, tetrasilane, methylsilane, dimethylsilane and chlorosilanes.

27. A process according to claim 1, wherein the particles formed in step (b) comprise at least 26 wt % of the electroactive material, or at least 28 wt % of the electroactive material, or at least 30 wt % of the electroactive material, or at least 32 wt % of the electroactive material, or at least 34 wt % of the electroactive material, or at least 36 wt % of the electroactive material, or at least 38 wt % of the electroactive material, or at least 40 wt % of the electroactive material, or at least 42 wt % of the electroactive material, or at least 44 wt % of the electroactive material, preferably wherein the electroactive material is silicon.

28. A process according to claim 26, wherein the weight ratio of silicon deposited in step (b) to the porous particles in the range from [0.50×P¹ to 1.9×P¹]:1, or from [0.6×P¹ to 1.8×P¹]:1 or from [0.7×P¹ to 1.7×P¹]:1, or from [0.8×P¹ to 1.6×P¹]:1, wherein P¹ is a dimensionless number having the same value as the total pore volume of micropores and mesopores in the porous particles as measured by gas adsorption as expressed in cm³/g.

29. A process according to claim 1, further comprising one or more of the following steps (c) to (g):
(c) subjecting the particles from step (b) to heat treatment at a temperature of at least 400° C. and in the presence of an inert gas;
(d) contacting the surface of the particles from step (b) or step (c) with a passivating agent;
(e) depositing a lithium ion permeable material into the pores and/or onto the outer surface of the composite particles from step (b), (c) or step (d);
(f) subjecting the particles from step (b), (c), (d) or (e) to a deagglomeration step to reduce the presence of agglomerated particles;
(g) classifying the composite particles from step (b), (c), (d), (e) or (f) such that the classified particles have a D₁ particle diameter of at least 0.5 μm.

30. A particulate material consisting of a plurality of composite particles, wherein the composite particles comprise:
(a) a porous particle framework comprising micropores and mesopores, wherein the micropores and mesopores have a total pore volume as measured by nitrogen gas adsorption of 0.4 to 2.0 cm³/g, and
(b) a plurality of nanoscale electroactive material domains located within the pores of the porous particle framework,
wherein the composite particles have a D₁ particle diameter of at least 0.5 μm, and a D₅₀ particle diameter in the range from 1 to 20 μm, and a BET surface area of no more than 50 m²/g.

31. A particulate material according to claim 30, wherein the D₁ particle diameter of the composite particles is at least 0.8 μm, or at least 1.0 μm, or at least 1.2 μm, or at least 1.4 μm, or at least 1.5 μm, or at least 1.6 μm, or at least 1.8 μm, or at least 2.0 μm, or at least 2.2 μm, or at least 2.4 μm, or at least 2.5 μm, or at least 2.6 μm, or at least 2.8 μm, or at least 3.0 μm.

32. A particulate material according to claim 30, wherein the D₅₀ particle diameter of the composite particles is in the range from 1.5 to 18 μm, or in the range from 1.5 to 15 μm, or in the range from 2 to 12 μm, or in the range from 2 to 10 μm, or in the range from 2.5 to 8 μm, or in the range from 3 to 8 μm.

33. A particulate material according to any of claim 30, wherein the D₉₀ particle diameter of the composite particles is no more than 30 μm, or no more than 25 μm, or no more than 20 μm, or no more than 18 μm, or no more than 16 μm, or no more than 15 μm, or no more than 12 μm.

34. A particulate material according to claim 33, wherein the D₁ particle diameter of the composite particles is in the range from 1.5 to 4.5 μm and the D₉₀ particle diameter is in the range from 9 to 15 μm, preferably wherein the D₁ particle diameter of the composite particles is in the range from 2 to 4 μm and the D₉₀ particle diameter is in the range from 10 to 14 μm, preferably wherein the D₁ particle diameter of the composite particles is in the range from 2.5 to 3.5 μm and the D₉₀ particle diameter is in the range from 11 to 13 μm.

35. A particulate material according to claim 30 wherein the D₉₈ particle diameter of the composite particles is no more than 35 μm, or no more than 30 μm, or no more than 25 μm, or no more than 20 μm, or no more than 18 μm, or no more than 16 μm, or no more than 15 μm, or no more than 12 μm.

36. A particulate material according to claim 30, wherein the D₁₀₀ particle diameter of the composite particles is no more than 40 μm, or no more than 35 μm, or no more than 30 μm, or no more than 25 μm, or no more than 20 μm.

37. A particulate material according to claim 30, wherein the difference between the D₉₈ particle diameter and the D₁ particle diameter of the composite particles (D₉₈−D₁) is no more than 18 μm, or no more than 16 μm, or no more than 15 μm, or no more than 14 μm, or no more than 13 μm, or no more than 12 μm.

38. A particulate material according to claim 30, wherein the ratio of the D₉₈ particle diameter to the D₁ particle diameter of the composite particles (D₉₈/D₁) is no more than 12, or no more than 10, or no more than 8, or no more than 6, or no more than 5.

39. A particulate material according to claim 30, wherein (D₉₈−D₁)/D₅₀ of the composite particles is no more than 2.2, or no more than 2, or no more than 1.9, or no more than 1.8, or no more than 1.7, or no more than 1.6.

40. A particulate material according to claim 30, wherein the difference between the D₉₀ particle diameter and the D₁ particle diameter of the composite particles (D₉₀−D₁) is no more than 12.0 μm, or no more than 10.0 μm, or no more than 9.0 μm, or no more than 8.0 μm.

41. A particulate material according to claim 30, wherein the ratio of the D₉₀ particle diameter to the D₁ particle diameter of the composite particles (D₉₀/D₁) is no more than 12.0, or no more than 10.0, or no more than 9.0, or no more than 8.0, or no more than 7.0, or no more than 6.0, or no more than 5.0.

42. A particulate material according to claim 30, wherein (D₉₀−D₁)/D₅₀ of the composite particles is no more than 2.2, or no more than 2, or no more than 1.9, or no more than 1.8, or no more than 1.7, or no more than 1.6.

43. A particulate material according to any of claims 30 to 42, wherein the ratio of the D₅₀ particle diameter to the D₁ particle diameter of the composite particles is no more than 10.0, or no more than 8.0, or no more than 7.0, or no more than 6.0, or no more than 5.0, or no more than 4.0, or no more than 3.0.

44. A particulate material according to claim 30, wherein the particle size distribution of the composite particles has a positive skew.

45. A particulate material according to claim 30, wherein the total pore volume of micropores and mesopores in the porous particle framework as measured by nitrogen gas adsorption is in the range from 0.4 to 1.8 cm³/g, or from 0.4 to 1.7 cm³/g, or from 0.5 to 1.6 cm³/g, or from 0.5 to 1.55 cm³/g, or from 0.6 to 1.5 cm³/g, or from 0.6 to 1.45 cm³/g, or from 0.65 to 1.4 cm³/g, or from 0.65 to 1.35 cm³/g, or from 0.7 to 1.3 cm³/g, or from 0.7 to 1.25 cm³/g, or from 0.75 to 1.2 cm³/g, or from 0.75 to 1.1 cm³/g, or from 0.8 to 1.15 cm³/g, or from 0.8 to 1.1 cm³/g.

46. A particulate material according to claim 30, wherein the PD₅₀ pore diameter of the porous particle framework is no more than 10 nm, or no more than 8 nm, or no more than 6 nm, or no more than 5 nm, or no more than 4 nm, or no more than 3 nm, or no more than 2.5 nm, or no more than 2 nm, or no more than 1.9 nm, or no more than 1.8 nm, or no more than 1.7 nm, or no more than 1.6 nm.

47. A particulate material according to claim 30, wherein the PD₉₀ pore diameter of the porous particle framework is in the range from 3.2 to 20 nm, or from 3.5 to 15 nm, or from 3.8 to 10 nm, or from 4 to 8 nm.

48. A particulate material according to claim 30, wherein the micropore volume fraction of the porous particle framework is at least 0.4, or at least 0.45, or at least 0.5, or at least 0.55, or at least 0.6 based on the total volume of micropores and mesopores.

49. A particulate material according to claim 30, wherein the micropore volume fraction of the porous particle framework is no more than 0.85, or no more than 0.8 based on the total volume of micropores and mesopores.

50. A particulate material according to claim 30, wherein the porous particle framework has a BET surface area in the range from 100 m²/g to 4,000 m²/g, or from 500 m²/g to 4,000 m²/g, or from 750 m²/g to 3,500 m²/g, or from 1,000 m²/g to 3,250 m²/g, or from 1,000 m²/g to 3,000 m²/g, or from 1,000 m²/g to 2,500 m²/g, or from 1,000 m²/g to 2,000 m²/g.

51. A particulate material according to claim 30, wherein the porous particle framework is a conductive porous particle framework, preferably a conductive porous carbon particle framework, more preferably a conductive porous carbon particle framework comprising at least 80 wt % carbon, or at least 85 wt % carbon, or at least 90 wt % carbon, or at least 95 wt % carbon.

52. A particulate material according to claim 30, wherein the electroactive material is selected from silicon, tin, germanium, aluminium and mixtures and alloys thereof, preferably wherein the electroactive material is silicon.

53. A particulate material according to claim 30, comprising at least 26 wt % of the electroactive material, or at least 28 wt % of the electroactive material, or at least 30 wt % of the electroactive material, or at least 32 wt % of the electroactive material, or at least 34 wt % of the electroactive material, or at least 36 wt % of the electroactive material, or at least 38 wt % of the electroactive material, or at least 40 wt % of the electroactive material, or at least 42 wt % of the electroactive material, or at least 44 wt % of the electroactive material, preferably wherein the electroactive material is silicon.

54. A particulate material according to claim 52, wherein the weight ratio of silicon to the porous particle framework is in the range from [0.50×P¹ to 1.9×P¹]:1, or from [0.6×P¹ to 1.8×P¹]:1 or from [0.7×P¹ to 1.7×P¹]:1, or from [0.8×P¹ to 1.6×P¹]:1, wherein P¹ represents a dimensionless number having the same value as the total pore volume of micropores and mesopores in the porous particle framework as measured by gas adsorption as expressed in cm³/g.

55. A particulate material according to claim 52, wherein at least 22 wt %, or at least 25 wt %, or at least 30 wt %, or at least 35 wt %, or at least 40 wt % of the silicon, or at least 45 wt % of the silicon in the composite particles is surface silicon as determined by thermogravimetric analysis (TGA).

56. A particulate material according to claim 52 wherein no more than 10 wt % of the silicon, or no more than 8 wt % of the silicon, or no more than 6 wt % of the silicon, or no more than 5 wt %,or no more than 4 wt %, or no more than 3 wt %, or no more than 2 wt % or no more than 1.5 wt % of the silicon in the composite particles is coarse bulk silicon as determined by thermogravimetric analysis (TGA).

57. A particulate material according to claim 30, wherein the composite particles have a BET surface area of no more than 100 m²/g, or no more than 80 m²/g, or no more than 60 m²/g, or no more than 50 m²/g, or no more than 40 m²/g, or no more than 30 m²/g, or no more than 25 m²/g, or no more than 20 m²/g, or no more than 15 m²/g, or no more than 10 m²/g, or no more than 5 m²/g.

58. A particulate material according to claim 30, further comprising a passivation layer formed on the surfaces of the nanoscale electroactive material domains, conductive carbon layer, a conductive metal layer, or a lithium-ion permeable solid electrolyte layer.

59. A particulate material according to claim 30, wherein the composite particles are non-agglomerated and non-aggregated particles.

60. A composition comprising the particulate material of claim 30 and at least one other component.

61. An electrode comprising the particulate material of claim 30.

62. A rechargeable metal-ion battery comprising the electrode of claim 61.
